(19) United States
(12) Patent Application Publication
(10) Pub. No.: US 2008/0093913 A1
(43) Pub. Date: Apr. 24, 2008

(54) Hub Motor Formed in a Wheel and Associated Methods

(76) Inventor: Stephen Basil Katsaros, Denver, CO (US)

Correspondence Address: Stephen B Katsaros, 2540 Forest Street, Denver, CO, 80207, US

(21) Appl. No.: 11/660,397

(22) PCT Filed: Aug. 22, 2005
(86) PCT No.: PCT/US05/29685

§ 371 Date: Feb. 15, 2007

Related U.S. Application Data
(60) Provisional application No. 60/604,532, filed on Aug. 25, 2004.

(51) Int. Cl. B60K 7/00; B60B 37/00

(52) U.S. Cl. 301/1; 301/6.5

(57) ABSTRACT

Disclosed herein is a hub motor (100) formed in a wheel (14) for assisting in the movement of a vehicle (10) and methods associated therewith. The present hub motor (100) and methods provide simple, inexpensive and reliable transportation. The hub motor (100) consumes minimal amounts of fuel, yet provides ample power for moving people and/or objects.

### RELATED APPLICATIONS

The present application is related to an International Application published under the Patent Cooperation Treaty. The International Publication Number is WO 03/098039 with a filing date of May 14, 2003 and International Application Number PCT/US03/15547. The International Application takes priority of now-abandoned U.S. Provisional Application No. 60/380,610 filed on May 15, 2002. This International Application has also matured into a U.S. National Stage application Ser. No. 10/514,264 filed on Nov. 12, 2004.

### BACKGROUND

Transportation devices have contained motors in the past. Certain limitations of these prior art motors have been realized. One of these limitations is that motors operate at a relatively high speed (e.g. 5,000 to 10,000 revolutions per minute) while wheels on vehicles operate at much lower speeds (e.g. a 26-inch bicycle wheel may operate at 256 revolutions per minute when traveling at 20 miles per hour).

### SUMMARY

In one exemplary embodiment disclosed herein, a wheel for a transportation device may include: an engine defining a piston axis; a first hub-half defining a first plane; a second hub-half defining a second plane; wherein the first hub-half is attached to the second hub-half; and wherein the first plane and the second plane are coplanar.

In another exemplary embodiment, a wheel for a transportation device may include: an engine formed in the wheel; an axle about which the wheel rotates; a starter non-rotatably engaged with the axle; and wherein the starter is translatingly engaged with the axle.

In another exemplary embodiment, a wheel for a transportation device may include: an axle about which the wheel rotates; a hub assembly rotationally supported by the axle; a carburetor attached to the hub assembly; a starter plate translatingly interfaced with the axle; and a yoke pivotally attached to the hub assembly, wherein the yoke is rotationally interfaced with the starter plate and controllingly interfaced with the carburetor.

In another exemplary embodiment, a wheel for a transportation device may include: an engine formed in the wheel, the engine creating torque; an axle about which the wheel and the engine rotate; a lever arm non-rotationally interfaced with the axle and fixedly attached to the transportation device; and wherein the torque is transferred from the engine to the transportation device via the lever arm.

In another exemplary embodiment, a wheel for a transportation device may include: an engine formed in the wheel; an axle about which the wheel rotates and a torque fuse formed between the engine and the axle.

In another exemplary embodiment, a wheel for a transportation device may include: an engine formed in the wheel; a carburetor in fluid communication with the engine; a crankcase formed in the hub; and a diaphragm pump in pneumatic communication with the crankcase and in fluid communication with the carburetor.

In another exemplary embodiment, a wheel for a transportation device may include: an axle about which the wheel rotates, the axle defining a first distal end; a fuel supply attached to the transportation device; an engine formed in the wheel; a fuel interface stationarly attached to the wheel; and a fuel passage formed in the axle, the fuel passage providing fluid communication between the first distal end and the carburetor via the fuel interface.

In another exemplary embodiment, a method of starting a motorized wheel may include: providing an engine formed in the motorized wheel; providing an axle about which the motorized wheel rotates; providing a torque fuse drivingly engaged with the axle and the engine; starting the engine; and while stating the engine, causing activation of the torque fuse.

In another exemplary embodiment, a wheel for a transportation device comprising: an engine formed in the wheel; a starter drivingly engaged to the engine; a carburetor in fluid communication with the engine; a starter/throttle mechanism in mechanical communication with the starter; and wherein the starter/throttle mechanism is in mechanical communication with the carburetor.

In another exemplary embodiment, a method for starting a motorized wheel for a transportation device, the method comprising: providing an engine formed in the wheel; providing a starter drivingly engaged to the engine; providing a carburetor in fluid communication with the engine; providing a starter/throttle mechanism in mechanical communication with the starter; wherein the starter/throttle mechanism is in mechanical communication with the carburetor; starting the engine by activating the starter/throttle mechanism; and after the starting the engine, controlling the engine with the starter/throttle mechanism.

### BRIEF DESCRIPTION OF THE DRAWING

Illustrative embodiments are shown in Figures of the Drawing in which:

FIG. 1 shows a schematic diagram of an exemplary vehicle (e.g. a bicycle) provided with a wheel including a hub motor.

FIG. 2 shows a front elevation view of an exemplary wheel provided with a hub motor.

FIG. 3 shows a perspective view of an axle.

FIG. 4 shows a plan view of the axle of FIG. 3.

FIG. 5 shows a cross-sectional view of the axle of FIG. 4 taken across plane 5-5 of FIG. 4.

FIG. 6 shows an enlarged portion of the axle of FIG. 5 taken at line 6 of FIG. 5.

FIG. 7 shows a perspective view of a sprocket BC assembly in an exploded condition.

FIG. 8 shows a perspective view of a sprocket F assembly in an exploded condition.

FIG. 9 shows a top plan view of the sprocket F assembly of FIG. 8 with an overrunning clutch removed therefrom.

FIG. 10 shows a partial cross-sectional view of the sprocket F assembly taken across plane 10-10 of FIG. 9.

FIG. 11 shows a perspective view of a starter plate.

FIG. 12 shows a top plan view of the starter plate of FIG. 11.

FIG. 13 shows a partial cross-sectional view of the starter plate of FIG. 12 taken across plane 13-13 of FIG. 12.

FIG. 14 shows a perspective view of an axle assembly in an exploded condition.

FIG. 15 shows a perspective view of a shaft DE assembly in an exploded condition.

FIG. 16 shows a perspective view of an exemplary torque fuse.

FIG. 17 shows a perspective view of a piston assembly in an exploded condition.

FIG. 18 shows a perspective view of an engine assembly in an exploded condition.

FIG. 19 shows a perspective view of a hub interface assembly in an exploded condition.

FIG. 20 shows a perspective view of a lever arm assembly.

FIG. 21 shows a plan view of a back surface of an as-cast hub.

FIG. 22 shows a partial cross-sectional view of a crankcase of the as-cast hub taken across plane 22-22 of FIG. 21.

FIG. 23 shows a partial cross-sectional view of an axle bearing mount taken across plane 23-23 of FIG. 21.

FIG. 24 shows a perspective view a right hub assembly in an exploded condition.

FIG. 25 shows a perspective view of a wheel provided with a hub motor in an exploded condition.

FIG. 26 shows a cross-sectional view of the wheel and hub motor of FIG. 25 taken across plane 26-26 of FIG. 2.

FIG. 27 shows an enlarged portion of the cross-sectional view of FIG. 26.

FIG. 28 shows an enlarged portion of the cross-sectional view of FIG. 26.

FIG. 29 shows a perspective view of a wheel and hub motor installed in a pair of forks.

FIG. 30 shows a top plan view of the wheel and hub motor of FIG. 29.

FIG. 31 shows a front elevation view of the wheel and hub motor of FIG. 29.

### DETAILED DESCRIPTION

Provided herein is a detailed description for an exemplary embodiment of a hub motor 100 contained within a wheel (e.g. a front wheel 14). The hub motor 100 may be utilized for any one of a variety of devices such as utility carts, tricycles, bicycles, recumbent vehicles, mini transportation vehicles, wheelbarrows, wheelchairs, pedicabs and other devices capable of moving from one location to another location. It should be noted that the description provided herein is directed to a bicycle 10. It is to be understood that the hub motor 100 may be utilized in any one of the previously mentioned devices or equivalents thereof.

This hub motor 100 contained in the wheel 14 allows for any of the above-mentioned devices to be motorized. The hub motor 100 is easy to install on an existing device (e.g. a bicycle as will be described herein) and easy to operate. In most situations, this installation takes less than 30 minutes. Once installed, the motorized bicycle can still be utilized as a traditional pedal-powered bicycle. However, when the user desires to have motorized assistance, the hub motor 100 is activated. The activated hub motor 100 creates energy that is harnessed to propel the bicycle. In one exemplary embodiment, this hub motor 100 is configured to operate on gasoline and to obtain speeds of 20 miles per hour.

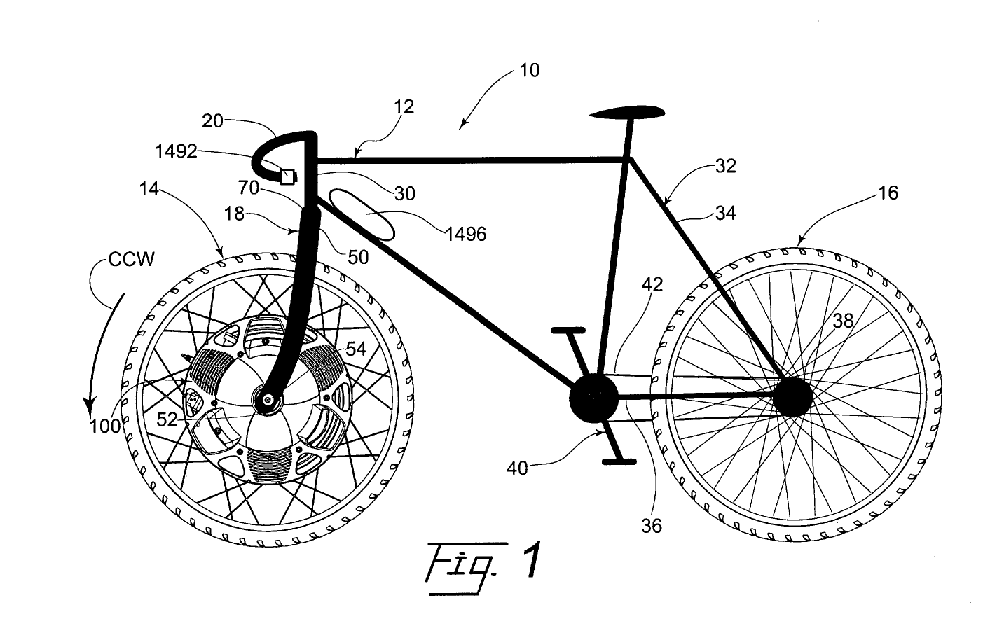

FIG. 1 shows the bicycle 10 provided with a frame 12, the front wheel 14, a rear wheel 16, a pair of forks 18 and a pair of handlebars 20. The frame 12 is provided with a headset 30 that may take the form of a hollow tube. The frame 12 is also provided with a rear triangle 32 which may include an upper member 34 and a lower member 36. The rear triangle upper and lower members 34, 36 form an intersection 38. The rear wheel 16 is rotationally mounted to the frame 12 at the rear triangle intersection 38. The bicycle 10 is conventionally provided with a pair of cranks 40 that are pivotally mounted to the frame 12. A chain 42 may rotationally couple the rear wheel 16 to the cranks 40.

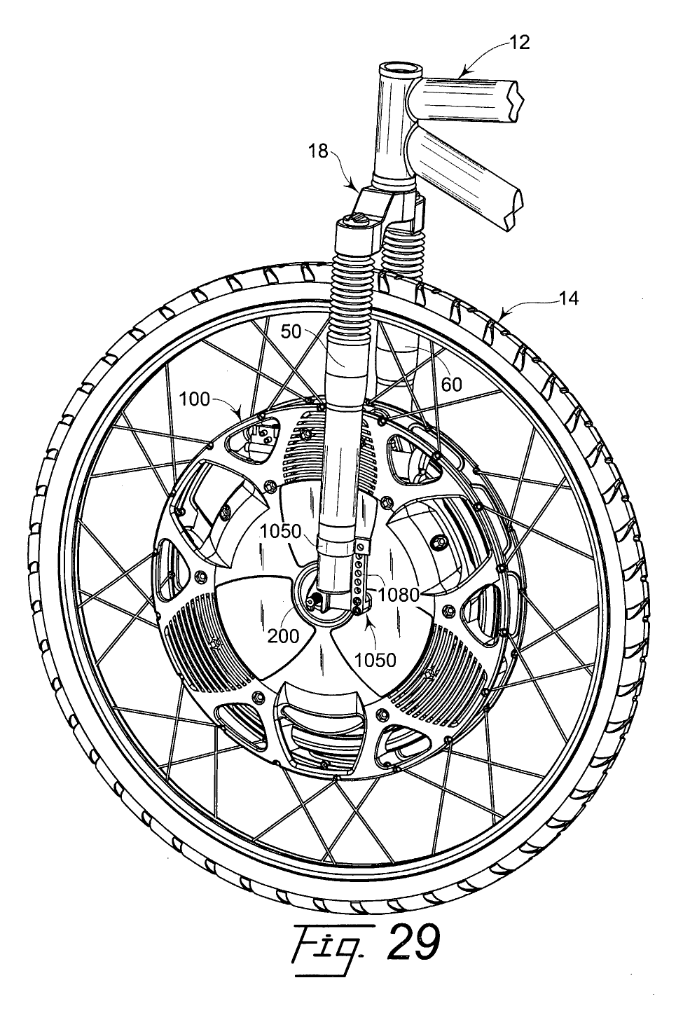

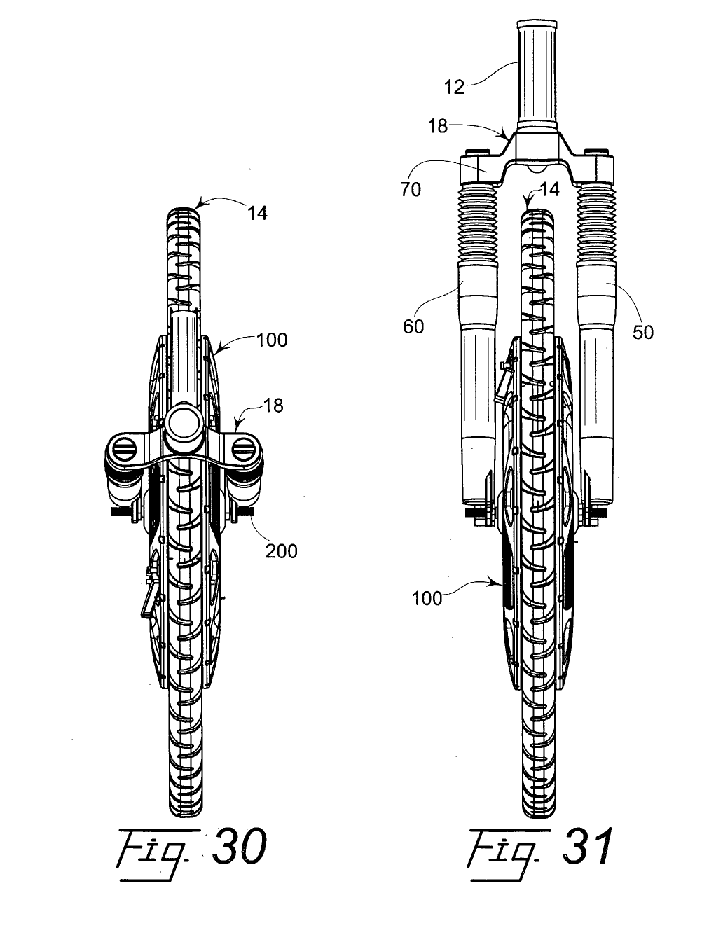

The pair of forks 18 may be provided with a first fork 50 and a second fork 60 (FIG. 29). The pair of forks 18 may be further provided with a crown 70 to which the first fork 50 and the second fork 60 may be fixedly attached. The crown 70 may be pivotally attached to the headset 30, thereby pivotally attaching the pair of forks 18 to the frame 12. The pair of handlebars 20 may be fixedly attached to the crown 70; rotation of the handlebars 20 may be mirrored by the forks 18. The first fork 50 may be provided with a distal end 52. The first fork distal end 52 may be provided with a mounting plate 54. With reference to FIG. 29, the second fork 60 may be provided with a distal end 62. The second fork distal end 62 may be provided with a mounting plate 64.

With reference to FIG. 1, the front wheel 14 may be rotationally mounted to the forks 18 at the first fork mounting plate 54 and the second fork mounting plate 64. Forward movement of the bicycle 10 causes counterclockwise rotation CCW of the front and rear wheels 14, 16. Likewise, rotation of the cranks 40 in a counterclockwise rotation CCW may cause the bicycle to move forward. It is noted that the terms such as ‘front’, ‘back’, ‘upper’, ‘lower’, ‘clockwise’, ‘counterclockwise’, ‘right’, ‘left’, ‘forward’, etc. are provided for illustrative purposes only and that these terms are relative to the orientation of the bicycle 10 or drawings thereof. Therefore, other orientations may be utilized while retaining the functionality of the device.

Either the front or rear wheel 14, 16 may be provided with a hub motor 100. It is noted that although the hub motor 100 is described herein and shown in the figures as a component of the front wheel 14, the hub motor 100 may be incorporated in the rear wheel 16 or other wheels provided with a vehicle.

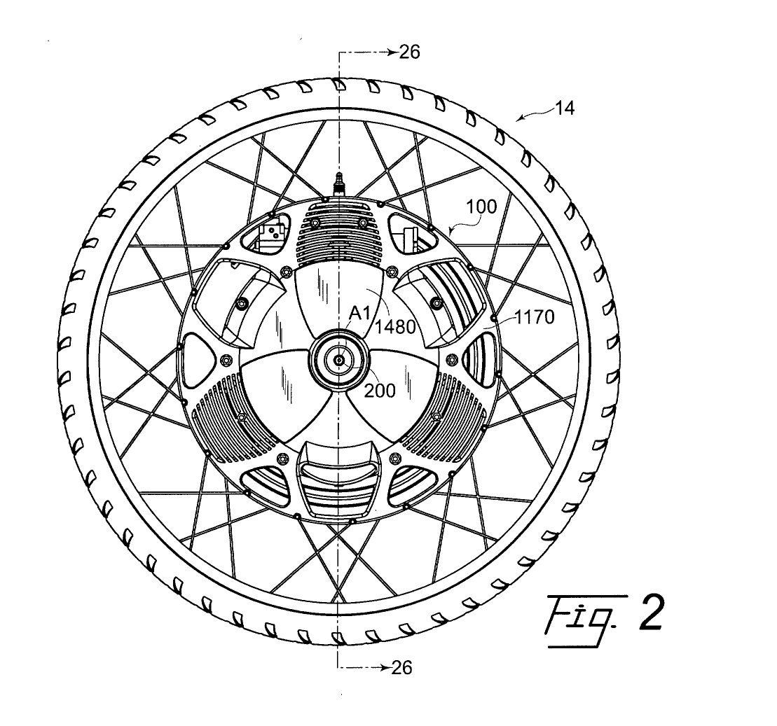

With reference to FIG. 2, the hub motor 100 is substantially located at the center of the wheel 14. The hub motor 100 may define a first axis A1 about which the hub motor 100 and the entire wheel 14 rotate. The hub motor 100 may be provided with an axle 200 about which the hub motor 100 rotates.

FIG. 3 illustrates a perspective view of the axle 200. With reference to FIG. 3, the axle 200 may take a generally cylindrical form having a variety of features incorporated therewith. The axle 200 is provided with a first end 202 and an oppositely disposed second end 204. The axle 200 is provided with threads 210 formed therein between the first end 202 and a first shoulder 212. The axle 200 may also provided with a moment interface 214 formed therein between the first shoulder 212 and a second shoulder 216. The moment interface 214 may take the form of any of a variety of configurations such as, for example, a four-sided square key as illustrated. FIG. 4 illustrates a plan view of the axle 200. With reference to FIG. 4, the axle moment interface 214 may be provided with a first flat 218, a second flat 220, a third flat 222 (FIG. 3) and a fourth flat 224 as illustrated.

With continued reference to FIG. 4, the axle 200 may be further provided with a first bearing surface 226. The first bearing surface 226 may originate at the second shoulder 216 and terminate at a third shoulder 228.

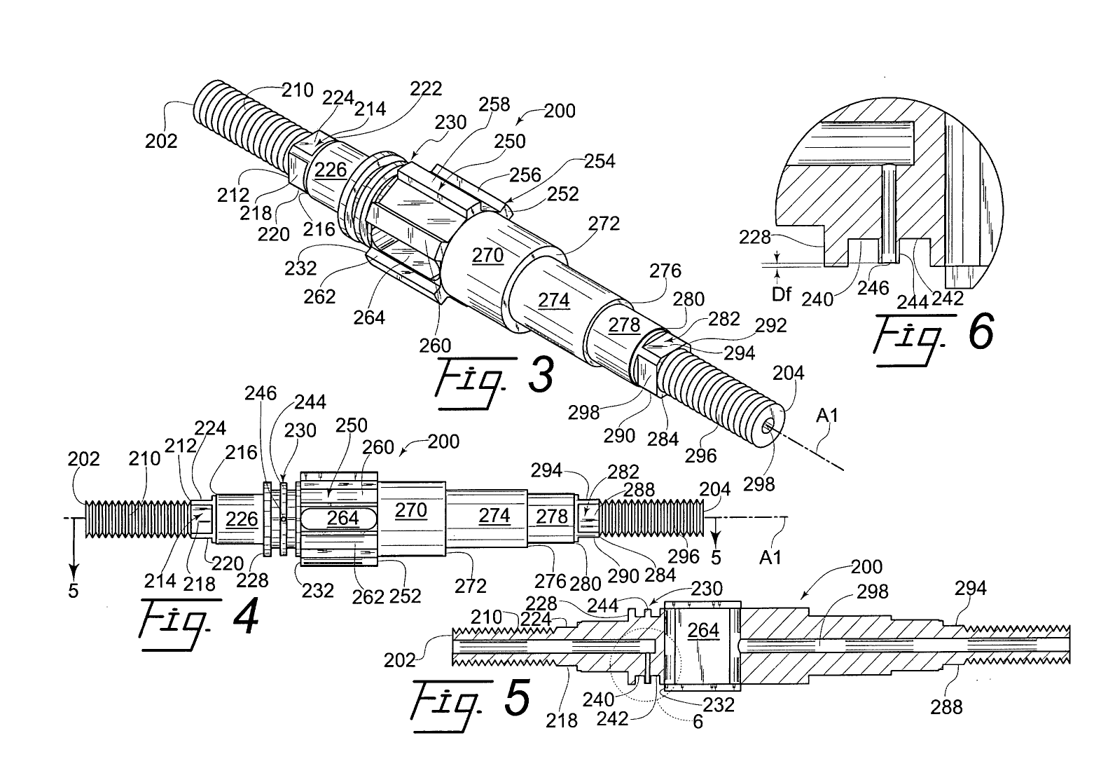

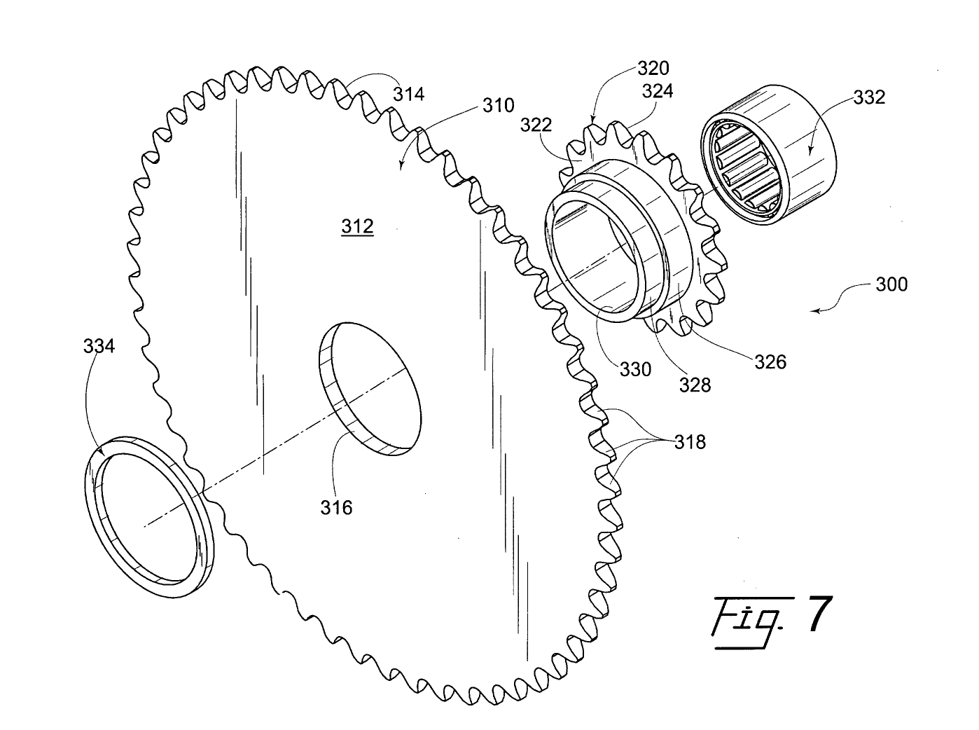

FIG. 5 illustrates a cross-sectional view of the axle 200 taken across line 5-5 in FIG. 4. The axle 200 may also be provided with a fuel interface 230 originating at the third shoulder 228 and terminating at a fourth shoulder 232. The fuel interface 230 may, for example, include a first groove 240, a second groove 242, a reduced section 244 and a fuel passage 246 (FIG. 6). As illustrated in FIG. 5, the first groove 242 may be separated from the second groove 242 by the reduced section 244. The first and second grooves 240, 242 may be formed to receive o-rings to seal the reduced section 244.

FIG. 6 illustrates an enlarged portion of the cross-sectional view of the axle 200 denoted by reference numeral 6 in FIG. 5. With reference to FIG. 6, the fuel passage 246 may be formed in the reduced section 244 and continue to the first distal end 202 (FIG. 5) of the axle 200. The reduced section 244 may be diametrically smaller than the diameter of the third shoulder 228 by a fuel distance Df as illustrated in FIG. 6. In one exemplary embodiment, this fuel distance Df is about 0.020 inches.

With reference to FIG. 3, the axle 200 may be further provided with a keyed interface 250. The keyed interface 250 may originate at the fourth shoulder 232 and terminate at a fifth shoulder 252. The keyed interface 250 may be provided with a plurality of keys 254 such as individual keys 256, 258, 260, 262. The axle 200 may be further provided with a slot 264. The slot 264 may be formed in-between two of the keys 254 (e.g. between keys 260, 262). Additionally the slot 264 may originate at the fourth shoulder 232 and terminate at the fifth shoulder 252.

With continued reference to FIG. 3, the axle 200 may be provided with a second bearing surface 270. The second bearing surface 270 may be formed between the fifth shoulder 252 and a sixth shoulder 272. The axle 200 may be further provided with a third bearing surface 274 formed between the sixth shoulder 272 and a seventh shoulder 276. The axle 200 may also be provided with a fourth bearing surface 278 formed between the seventh shoulder 276 and an eighth shoulder 280.

With continued reference to FIG. 3, the axle 200 may be provided with a second moment interface 282 formed therein between the eighth shoulder 280 and a ninth shoulder 284. The second moment interface 282 may take the form of any of a variety of configurations such as, for example, a four-sided square key as illustrated. The axle second moment interface 282 may be provided with a first flat 288, a second flat 290, a third flat 292 and a fourth flat 294 as illustrated. The axle 200 may be further provided with threads 296 formed between the ninth shoulder 284 and the second distal end 204. With reference to FIG. 5, the axle 200 may be provided with a cavity 298 formed between the second distal end 204 and the slot 264.

FIG. 7 illustrates an exploded view of a BC sprocket assembly 300. The BC sprocket assembly 300 may be provided with a sprocket B 310, a sprocket C 320, a needle bearing 332 and a spacer 334. The sprocket B 310 is provided with a first surface 312 and an oppositely disposed second surface 314. The sprocket B 310 is provided with a hole 316 concentrically centered therein and formed between the first and second surfaces 312, 314. Additionally sprocket B 310 is provided with a plurality of teeth 318. These plurality of teeth 318 may take a variety of forms such as, for example, teeth for a roller chain as illustrated.

With continued reference to FIG. 7, the sprocket C 320 may be provided with a first surface 322 and an oppositely disposed second surface 324. The sprocket C 320 is provided with a hub 326 formed on the first surface 322. This hub 326 may be provided with a shoulder 328 formed therein. Additionally, the sprocket C 320 is provided with a hole 330 formed therein.

The sprocket BC assembly 300 may be constructed by attaching sprocket C 320 to sprocket B 310. One exemplary method for attaching the sprockets 310, 320 is to solder the sprockets together. When soldered together, sprocket C shoulder 328 may separate the sprocket C first surface 322 from the sprocket B second surface 314. It should be noted that this assemblage of sprockets C and B 320, 310 may occur through any of a variety of other manufacturing techniques. Additionally, the sprocket BC assembly 300 may be completed by press-fitting the needle bearing 332 into sprocket C 320 and pressing the spacer 334 onto the sprocket C shoulder 328.

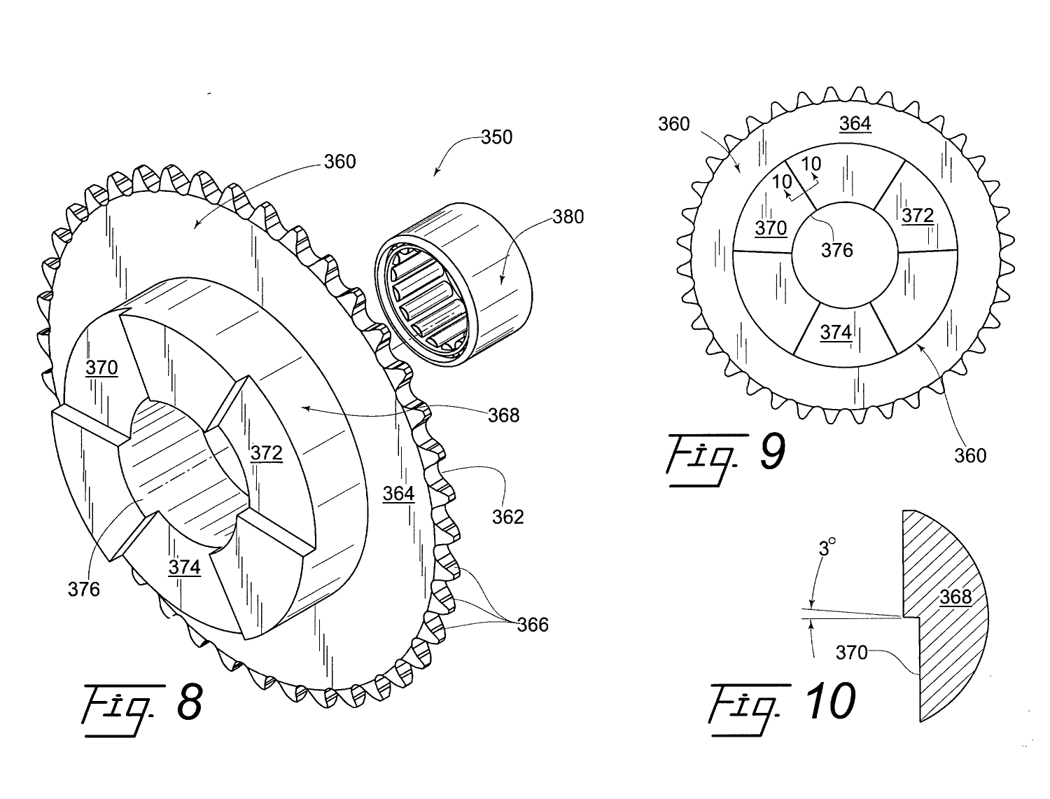

FIG. 8 shows a perspective view of a sprocket F assembly 350 in an exploded condition. With reference to FIG. 8, the sprocket F assembly 350 may be provided with a sprocket F 360 and an overrunning clutch 380. The sprocket F 360 is provided with a first surface 362 and an oppositely disposed second surface 364. Additionally, the sprocket F 360 may be provided with a plurality of teeth 366, and a hub 368. The hub 368 is formed on the second surface 364. The sprocket F hub 368 may be provided with a plurality of dogs 370, 372, 374 formed therein. FIG. 9 shows a plan view of the sprocket F 350 and FIG. 10 shows a cross-sectional view of dog 370 taken across line 10-10 in FIG. 9. With reference to FIG. 10, the dogs (e.g. dog 370) may be formed in the hub 368 with a tapered face as illustrated. This face of the dog 370 may be formed at any of a variety of degrees. As illustrated in FIG. 10, the face may be tapered by about 3 degrees. This taper may be anywhere from a fraction of a degree to about 45 degrees; in one exemplary embodiment, the range of taper for the face of the dog 370 is between 1 and 10 degrees. Additionally, sprocket F 360 is provided with a hole 376 formed therein. Sprocket F assembly 350 is configured such that the overrunning clutch 380 is permanently fixed to the sprocket F hole 376.

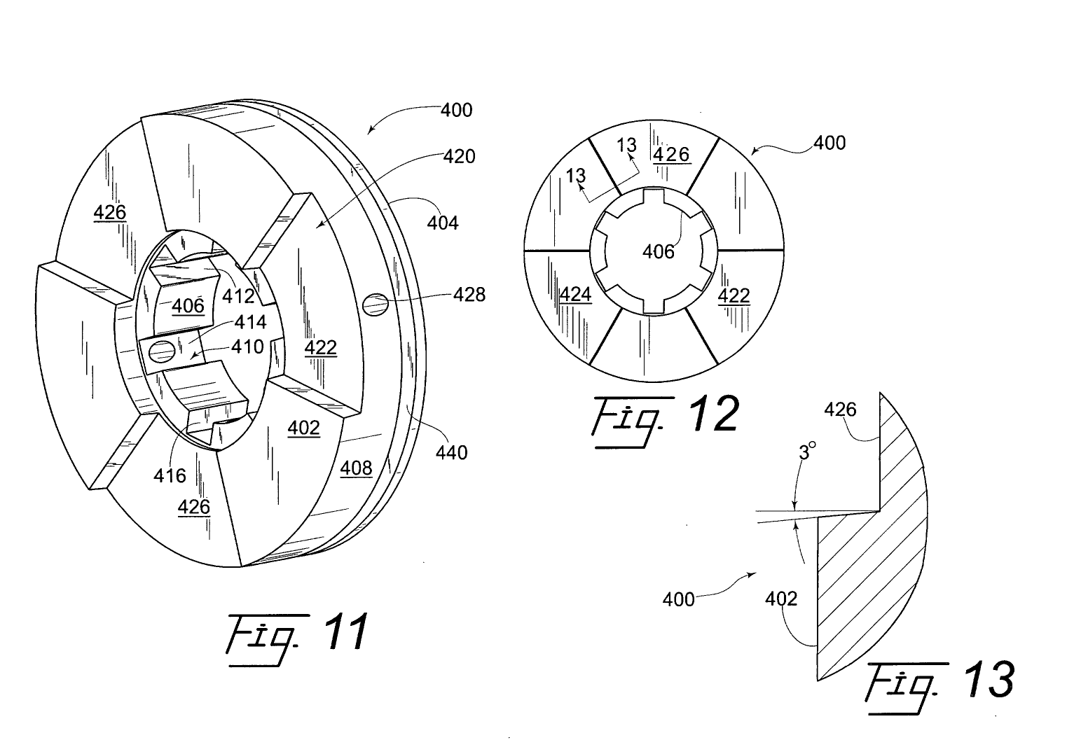

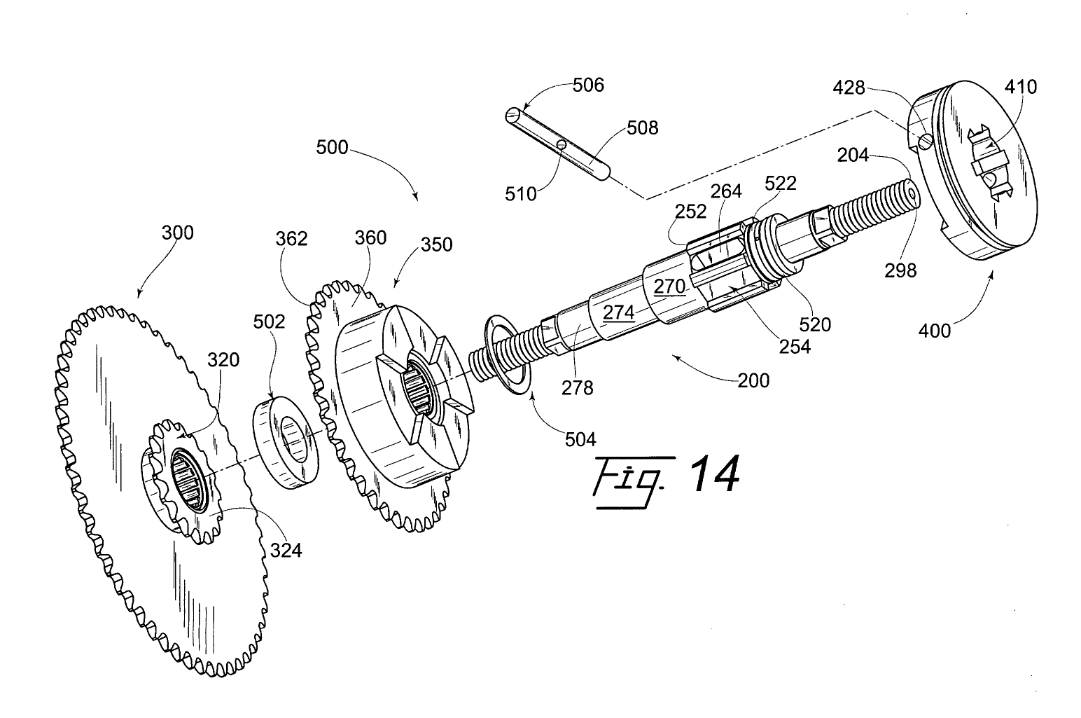

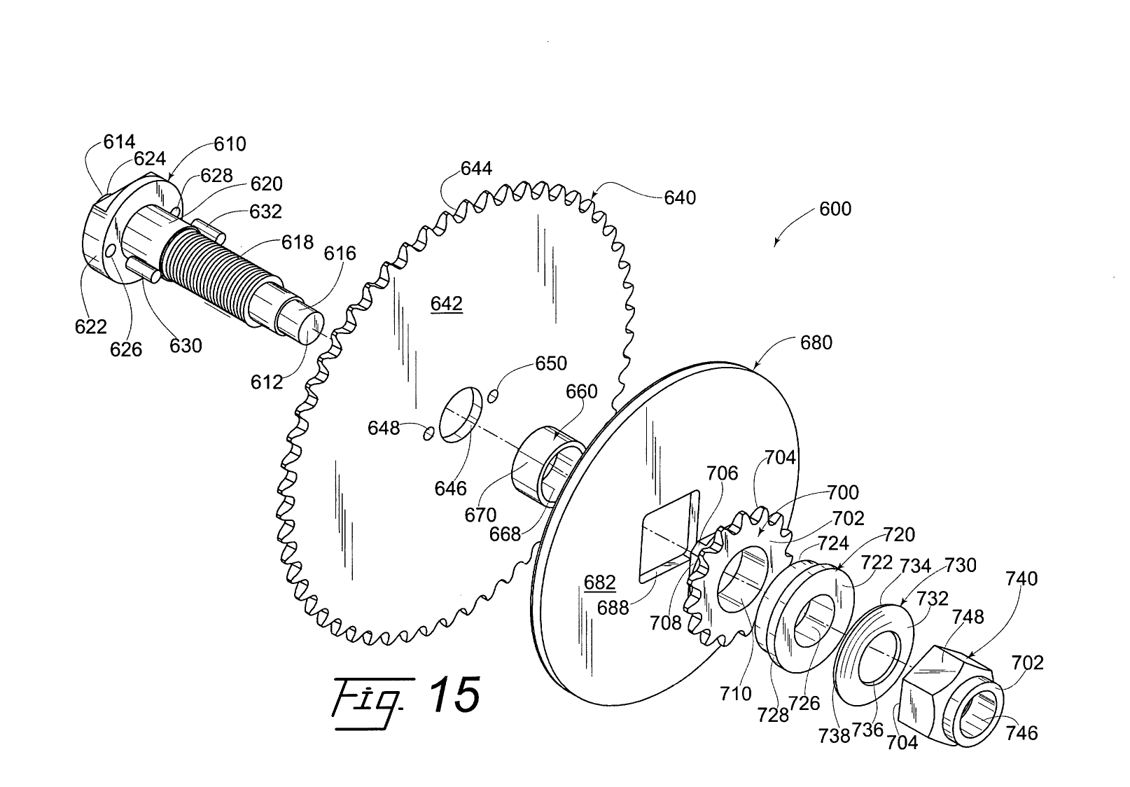

FIG. 11 shows a perspective view of a starter plate 400. The starter plate 400 is provided with a first surface 402 and an oppositely disposed second surface 404. The starter plate 400 is also provided with an internal bore 406 and an outer cylindrical surface 408 concentric to the internal bore 406. The starter plate 400 may be provided with a plurality of keyways 410 such as individual keyways 412, 414, 416. These keyways 410 may be formed in the internal bore 406 and extending from the first surface 402 to the second surface 404. The starter plate 400 may be provided with a plurality of dogs 420 such as individual dogs 422, 424, 426. FIG. 12 shows a plan view of the starter plate 400 and FIG. 13 shows a cross-sectional view of one of dogs 426 taken across line 13-13 in FIG. 12. With reference to FIG. 13, the dogs 420 (e.g. dog 426) may be formed in the starter plate 400 with a tapered face as illustrated. This face of the dog 426 may be formed at any of a variety of degrees. As illustrated in FIG. 13, the face may be tapered by about 3 degrees. This taper may be anywhere from a fraction of a degree to about 45 degrees; in one exemplary embodiment, the range of taper for the face of the dog 426 is between 1 and 10 degrees. The starter plate 400 may also be provided with a circumferential groove 440 formed in the outer cylindrical surface 408. This circumferential groove 440 may extend entirely around the outer cylindrical surface 408. The starter plate 400 may also be provided with a hole 428 formed through one of the plurality of keyways 410 and extending to the key diametrically-opposite therefrom as illustrated in FIG. 11. It should be noted that the starter plate 400 may also be referred to herein as a starter/throttle mechanism.

FIG. 14 shows a perspective view of an axle assembly 500 in an exploded condition. With reference to FIG. 14, the axle assembly 500 may include various components such as, for example, the axle 200, the sprocket BC assembly 300, a spacer BC 502, the sprocket F assembly 350, a spacer F 504, the starter plate 400 and a throttle pin 506. As illustrated, the axle assembly 500 may be assembled by inserting the spacer F 504 onto the axle 200 such that the spacer F 504 contacts the axle fifth shoulder 252 near the second bearing surface 270. The next component to be assembled onto the axle assembly 500 is the sprocket F assembly 350. Sprocket F assembly 350 may be positioned such that it captures spacer F 504 and is located on the second bearing surface 270. Next, the spacer BC 502 may be positioned in the axle assembly 500 such that it contacts the first surface 362 of sprocket F 360 and also contacts the third bearing surface 274 of the axle 200. Additionally, the sprocket BC assembly 300 may be assembled to the axle assembly 500 such that the second surface 324 of the sprocket C 300 contacts the spacer BC 502; additionally, the needle bearing 332 contacts the third bearing surface 274 of the axle 200.

With continued reference to FIG. 14, the throttle pin 506 may take a cylindrical form consisting of an outer surface 508. The throttle pin 506 may be provided with a hole 510 formed therein at the approximate center of the throttle pin 506. In one exemplary embodiment, the hole 510 may take the form of a threaded hole for receiving a component of the throttle system.

With continued reference to FIG. 14, the axle assembly 500 may be further assembled by sliding the starter plate 400 over the axle 200. When the starter plate 400 is assembled with the axle 200, the plurality of keyways 410 of the starter plate 400 are interfaced with the plurality of keys 254 formed in the axle 200. Furthermore, the hole 428 formed in the starter plate 400 is positioned collinearly to the slot 264 formed in the axle 200. In order to capture the starter plate 400 onto the axle 200, the throttle pin 506 may be pressed into the hole 428 formed in the starter plate 400. When pressing the throttle pin 506 into the starter plate hole 428, the throttle pin hole 510 may be positioned coaxial to the cavity 298 formed between the axle second distal end 204 and the axle slot 264. This installation of the starter plate 400 results in a starter plate 400 that is non-rotatably engaged to the axle 200. Additionally, this installation results in a starter plate 400 that is translatingly engaged to the axle 200. It is noted that the interface consisting of the plurality of keyways 410 formed in the starter plate 400 and the plurality of keys 254 formed in the axle 200 is one exemplary embodiment. This interface may consist of any of a variety of other configurations such as slots, holes, pins, keys, blocks, rails or any of a variety of other interfaces practiced in industry.

With continued reference to FIG. 14, the axle assembly 500 may be further assembled by installing a pair of o-rings 520, 522. The first o-ring 520 may be positioned in the first groove 240 (FIG. 5) of the axle 200. The second o-ring 522 may be positioned in the second groove 242 (FIG. 5). These o-rings may be composed of a material compatible with fuel (e.g. fluoroelastomer when gasoline is used as a fuel). These o-rings 520, 522 inherently contain sealing surfaces. These sealing surfaces may be substituted or otherwise altered while retaining the intended function of containing fuel.

FIG. 15 shows a perspective view of a shaft DE assembly 600 in an exploded condition. With reference to FIG. 15, the shaft DE assembly 600 may be provided with a shaft DE 610, a pair of pins 630, 632, a sprocket D 640, a bushing E 660, a torque fuse 680, a sprocket E 700, a spacer E 720, a spring 730 and an adjustment nut 740.

With continued reference to FIG. 15, the shaft DE 610 may be provided with a first distal end 612 and an oppositely disposed second distal end 614. The shaft DE 610 may be further provided with a first bearing surface 616, a threaded portion 618, a torque fuse bearing surface 620, a shoulder 622 and a second bearing surface 624. The shaft DE 610 may be configured such that the features thereof are linearly configured on the shaft DE 610. Moving from the first distal end 612 toward the second distal end 614, the first bearing surface 616 may be formed at the first distal end 612. The threaded portion 618 may be formed adjacent to the first bearing surface 616. The torque fuse bearing surface 620 may be formed adjacent to the threaded portion 618 formed adjacent to the first distal end 612. The shoulder 622 may be formed adjacent to the torque fuse bearing surface 620. The second bearing surface 624 may be formed adjacent to the shoulder 622. Additionally, the shaft DE 610 may be provided with a pair of holes 626, 628 formed in the shoulder 622.

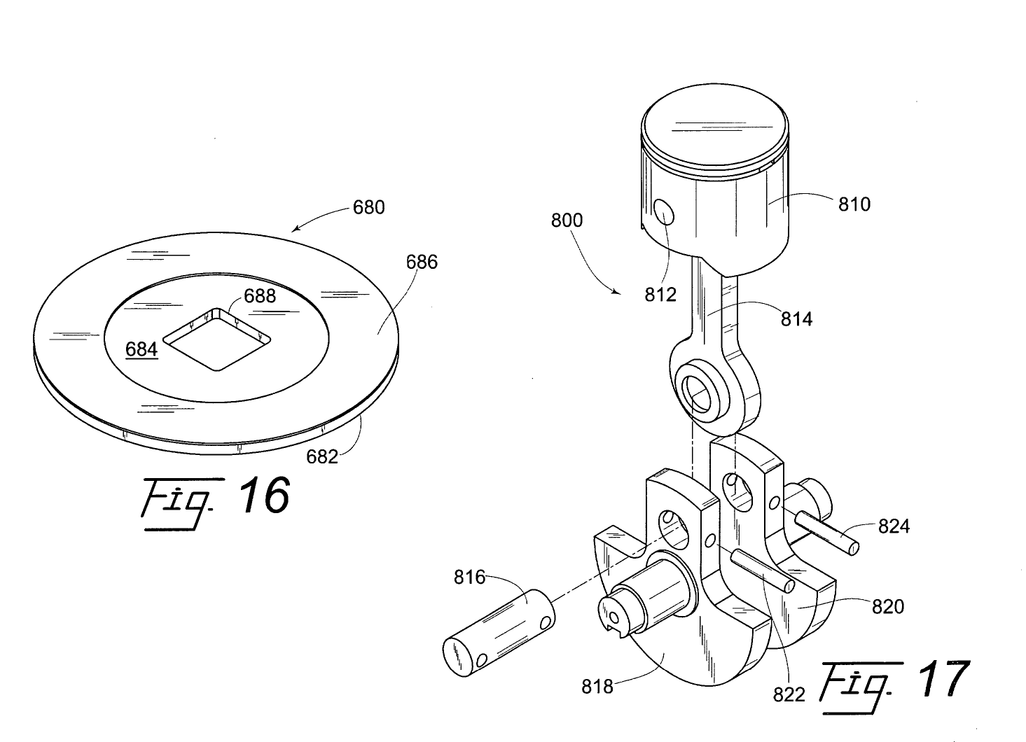

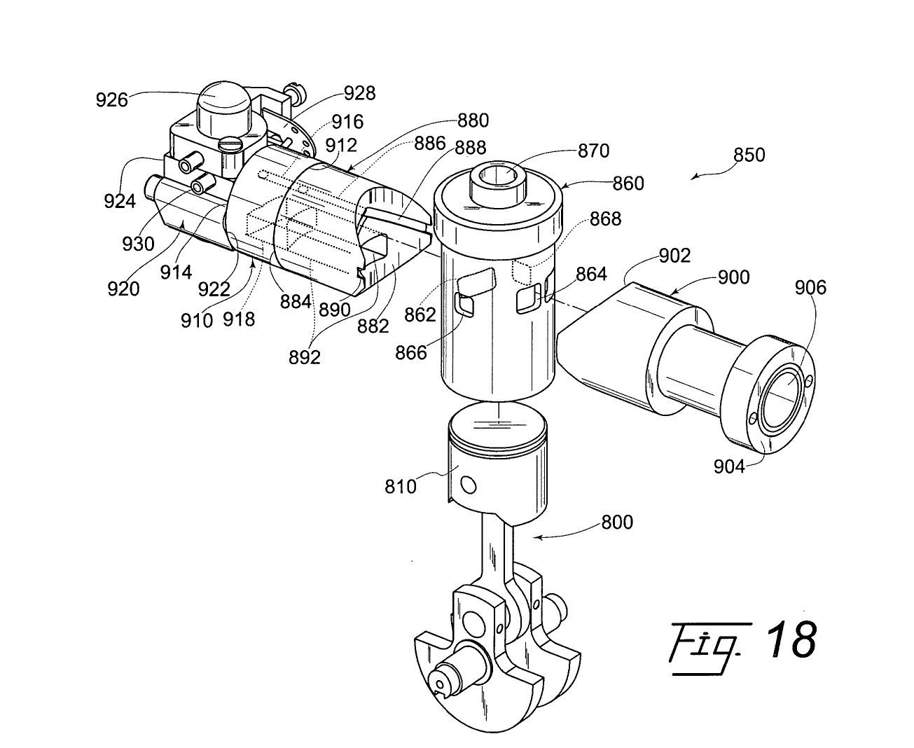

With continued reference to FIG. 15, the sprocket D 640 may be provided with a first surface 642 and an oppositely disposed second surface 644. The sprocket D 640 may be further provided with a central hole 646 and a pair of pin holes 648, 650. The bushing E 660 may be provided with a first distal end 662 and an oppositely disposed second distal end 664. The bushing E 660 may be further provided with an internal surface 668 and an external surface 670. The torque fuse 680 may be provided with a first surface 682 and an oppositely disposed second surface 684 (FIG. 16). FIG. 16 shows a perspective view of the back side of the torque fuse 680. With reference to FIG. 16, the torque fuse 680 may be provided with a friction material 686 formed on the second surface 684. This friction material 686 may be composed of any of a wide variety of materials such as, for example, brake lining, clutch lining, or any other material known for its relatively high coefficient of friction. Additionally, the torque fuse 680 may be provided with an interface 688 such as the illustrated square interface formed between the first and second surfaces 682, 684.

With reference to FIG. 15, the sprocket E 700 may be provided with a first surface 702 and an oppositely disposed second surface 704. The sprocket E 700 may be further provided with a shoulder 706 formed on the second surface 704. The sprocket E 700 may be further provided with an interface 708 formed in the shoulder 706. Furthermore, the sprocket E 700 may be provided with a hole 710 formed therethrough. The spacer E 720 may be provided with a first distal end 722 and an oppositely disposed second distal end 724. The spacer F 720 may be further provided with an internal surface 726 and an external surface 728. The spring 730 may be provided with a first distal end 732 and an oppositely disposed second distal end 734. The spring 730 may be further provided with an internal surface 736 and an external surface 738. In one exemplary embodiment, the spring 730 may take the form of a disk washer. The adjustment nut 740 may be provided with a first distal end 742 and an oppositely disposed second distal end 744. The adjustment nut 740 may be further provided with an internal surface 746 and an external surface 748. The internal surface 746 may be formed with threads capable of interfacing with the threaded portion 618 of the shaft DE 610. The external surface 748 may be formed with a plurality of flats for readily engaging a wrench.

As illustrated in the exploded state in FIG. 15, the shaft DE assembly 600 may be assembled by pinning the sprocket D 640 to the shaft DE 610 with the pair of pins 630, 632. As illustrated, the first pin 630 may be positioned in the sprocket D first hole 648 and the shaft DE first hole 626. Additionally, the second pin 632 may be positioned in the sprocket D second hole 650 and the shaft DE second hole 628. This pinning may result in sprocket D 640 being non-rotatably attached to shaft DE 610. The bushing E 660 may be assembled by placing the bushing E internal surface 668 into contact with the torque fuse bearing surface 620. The torque fuse 680 may be captured between the sprocket D 640 and the sprocket E 700. Additionally, the torque fuse 680 may be non-rotatably interfaced with the sprocket E 700 via the torque fuse interface 688 and the sprocket E interface 708.

With continued reference to FIG. 15, the spacer E 720 may be positioned with the second distal end 724 adjoining the sprocket E first surface 702. Additionally, the sprocket E hole 710 may be concentric to and in contact with the threaded portion 618 of the shaft DE 610. Continuing with the assembly of the shaft DE assembly 600, the spring 730 may be positioned with the second distal end 734 adjoining the spacer F first distal end 722. The assembly may be completed by threadingly engaging the adjustment nut 740 with the shaft DE 610.

This shaft DE assembly 600 may allow for the sprocket D 640 and sprocket E 700 to rotate together when the first and second bearing surfaces 616, 624 are supported (this condition may be referred to herein as a drive condition). In another condition, referred to herein as a slip condition, the torque fuse 680 may rotate with respect to the sprocket D 640. The force required to cause this slip condition is adjustable via the adjustment nut 740 that applies a compressive force on the spring 730. Accordingly, when the torque being transmitted between sprocket D 640 and sprocket E 700 exceeds a predetermined amount set via the adjustment nut 740, the torque fuse friction material 686 slides on the sprocket D first surface 642. This slip condition protects the components of the hub motor 100 from excessive forces.

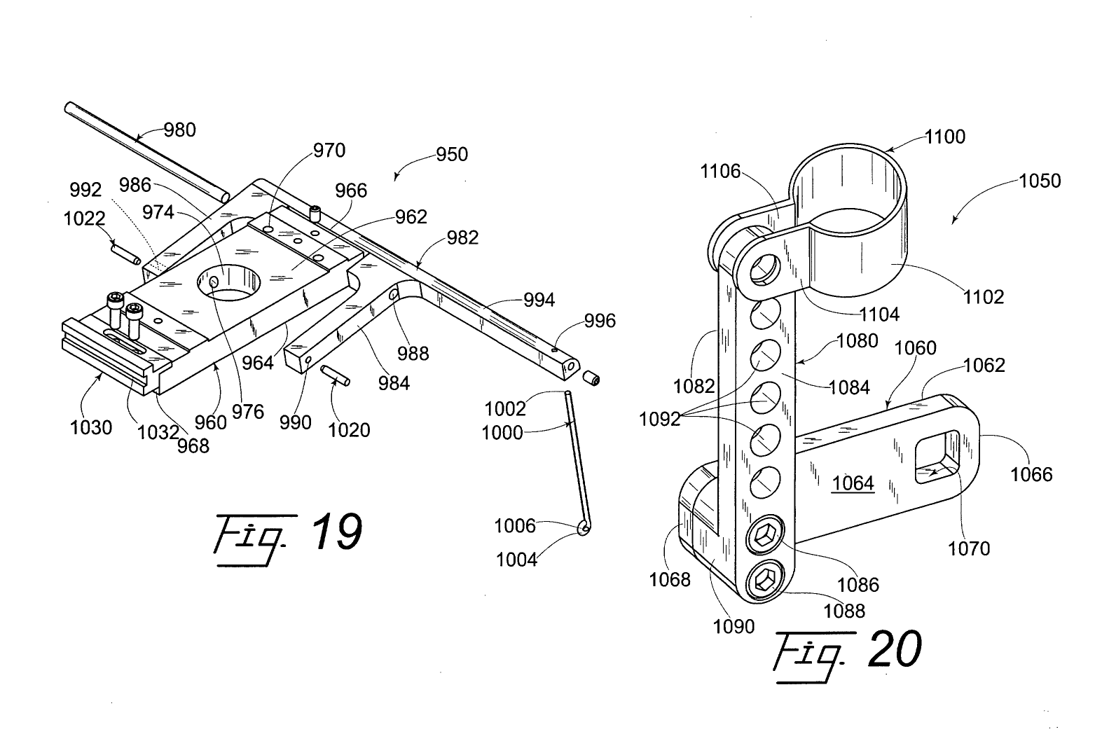

FIG. 17 shows a piston assembly 800 in an exploded condition. With reference to FIG. 17, the piston assembly 800 may be provided with a piston 810, a piston pin 812, a connecting rod 814, a journal pin 816, a first cheek plate 818 and a second cheek plate 820. The piston 810 is rotatably attached to the connecting rod 814 with the piston pin 812. The connecting rod 814 is rotatably attached to the first and second cheek plates 818, 820 via the journal pin 816. It should be noted that although there are a number of ways to attach the journal pin 816 to the cheek plates 818, 820, the method illustrated in FIG. 17 is the utilization of a pair of pins 822, 824. It should be noted that the piston 810 defines a piston axis that is located concentric to the main diametrical surface of the piston 810. This piston axis resides in the first plate P1.

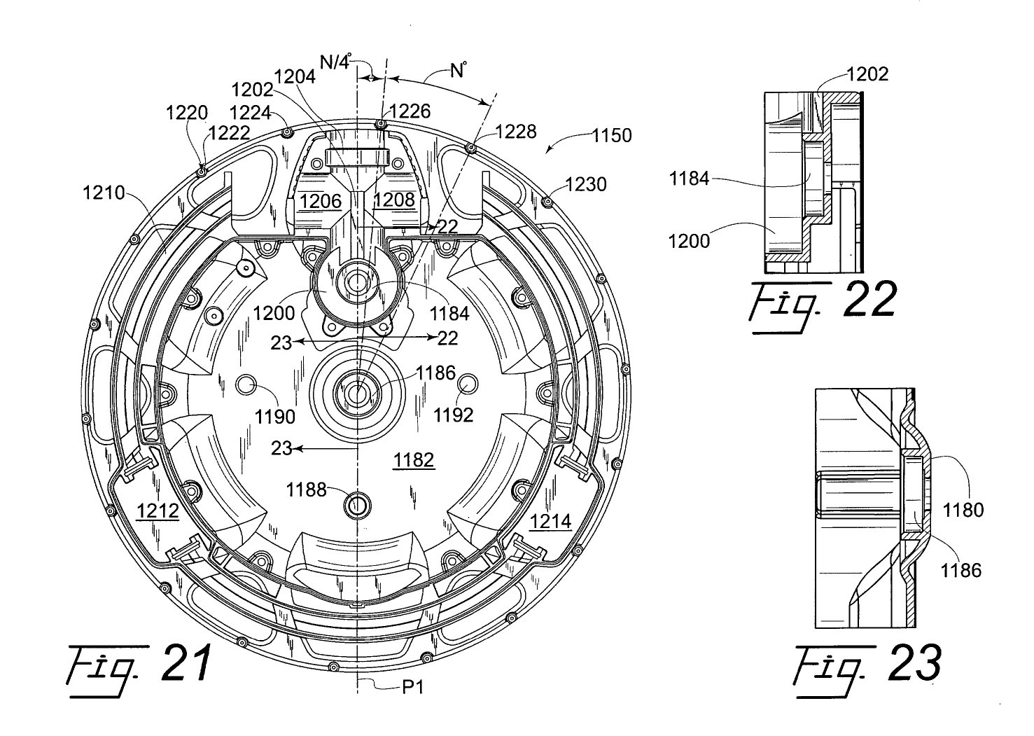

FIG. 18 shows an engine assembly 850 in an exploded condition. With reference to FIG. 18, the engine assembly 850 may be provided with the piston assembly 800, a sleeve 860, an intake manifold 880, an exhaust manifold 900, a carburetor insulator 910, a carburetor 920 and a spark plug 1470 (FIG. 25). The sleeve 860 may take the form of a close-ended tube with a plurality of ports formed therein. The sleeve 860 may be provided with an intake port 862, an exhaust port 864, a first transfer port 866 and a second transfer port 868. The intake port 862 is oppositely disposed from the exhaust port 864. The transfer ports 866, 868 are oppositely disposed from each other and perpendicularly disposed from the intake and exhaust ports 862, 864. The sleeve 860 may be further provided with a sparkplug hole 870 for threadingly engaging the spark plug 1470 (FIG. 25).

With continued reference to FIG. 18, the intake manifold 880 may take a generally cylindrical form having a first distal end 882 and an oppositely disposed second distal end 884. The first distal end 882 may be formed with a concave profile capable of sealingly engaging the sleeve. The intake manifold 880 may be further provided with a diaphragm passage 886 extending from the first distal end 882 to the second distal end 884. The intake manifold 880 may be further provided with a pair of bypass passages 888, 890 formed in the first distal end and in pneumatic communication with the diaphragm passage 886 and the transfer ports 866, 868 of the sleeve 860 (when assembled). The intake manifold 880 may be further provided with an intake passage 892 that is formed from and through the first and second distal ends 882, 884. This intake passage 892 is in fluid communication with the intake port 862 of the sleeve 860.

With continued reference to FIG. 18, the exhaust manifold 900 may take a generally cylindrical form having a first distal end 902 and an oppositely disposed second distal end 904. The first distal end 902 may be formed with a concave profile capable of sealingly engaging the sleeve 860. The exhaust manifold 900 may be further provided with an exhaust passage 906 that is formed in and through the first and second distal ends 902, 904. This exhaust passage 906 is in fluid communication with the exhaust port 864 of the sleeve 860.

With continued reference to FIG. 18, the carburetor insulator 910 may take a generally cylindrical form having a first distal end 912 and an oppositely disposed second distal end 914. The carburetor insulator 910 may be provided with a diaphragm passage 916 and an intake passage 918. The passages 916, 918 are formed in and extending through the first and second distal ends 912, 914. The first distal end 912 may be fastened adjacent to the second distal end 884 of the intake manifold 880.

With continued reference to FIG. 18, the carburetor 920 may be provided with a first distal end 922 and an oppositely disposed second distal end 924. The carburetor 920 may be further provided with a primer 926, a throttle plate 928, a fuel inlet 930 and a choke 932 (not shown). The first distal end 922 may be fastened adjacent to the second distal end 914 of the carburetor insulator 910. The primer 926, throttle plate 928, fuel inlet 930 and choke 932 operate in a similar manner to other carburetors utilized within industry. It should be noted that the carburetor 920 is of the variety having a fuel pump located therein. One exemplary type of carburetor provided with a fuel pump is a carburetor provided with a diaphragm pump. The diaphragm pump utilizes the crankcase pressure. In the present apparatus, the crankcase pressure is directed to the carburetor 920 via the bypass passages 888,890, the intake manifold diaphragm passage 886 and the carburetor insulator diaphragm passage 916. The pressure of the crankcase alternates and drives a plastic diaphragm back and forth as a series of check valves control the flow of fuel within the carburetor 920.

FIG. 19 shows a hub interface assembly 950 in an exploded condition. With reference to FIG. 19, the hub interface assembly 950 may be provided with a hub interface 960, a throttle yoke pivot pin 980, a throttle yoke 982, a wire hook 1000, a pair of interface pins 1020, 1022 and an ignition bracket 1030. The hub interface 960 may be provided with a first surface 962 and an oppositely disposed second surface 964. The hub interface 960 may be further provided with first distal end 966 and an oppositely dispose second distal end 968. The hub interface 960 may be provided with a variety of attachment holes 970, 972, an axle hole 974, a fuel delivery hole 976 and a throttle yoke pivot hole 978. The attachment holes 970, 972 may be formed in the first surface 962 and may, for example, take the form of threaded holes. The axle hole 974 may be formed in the hub interface 960 and extend from the first surface 962 through the second surface 964. The fuel delivery hole 972 is formed in the hub interface 960 and allows for fluid communication with the axle hole 974. The throttle yoke pivot hole 978 may be formed in the first distal end 966 of the hub interface 960.

With continued reference to FIG. 19, the throttle yoke 982 may be provided with a first tang 984, a second tang 986, a pivot hole 988, a first interface pin hole 990, a second interface pin hole 992, a stretch bar 994 and a wire hook hole 996. The tangs 984, 986 may extend from the main body of the throttle yoke 982 as illustrated in FIG. 19. The pivot hole 988 may be formed in the tangs 984, 986. The first interface pin hole 990 may be formed in the first tang 984 such that the first pin interface hole 990 is parallel to the pivot hole 988. The second interface pin hole 992 may be formed in the second tang 986 such that the second pin interface hole 992 is parallel to the pivot hole 988. The stretch bar 994 may be integrally formed with the main body and tangs 984, 986 and extend in a direction substantially parallel to the pivot hole 988. The wire hook hole 996 may be formed in the stretch bar 994. The hub interface assembly 950 may be assembled by attaching the throttle yoke 982 to the hub interface 960 via the throttle yoke pivot pin 980. This attachment may occur by installing (and retaining) the throttle yoke pivot pin 980 into the throttle yoke pivot hole 978 while capturing the throttle yoke 982.

The wire hook 1000 may be formed of any of a variety of materials capable of resisting a lateral force, but ultimately yielding to the force. One such material of choice for the wire hook 1000 is steel wire. As illustrated in FIG. 19, the wire hook 1000 may be provided with a first distal end 1002 and an oppositely disposed second distal end 1004. The first distal end 1002 may be capable of interfacing with the wire hook hole 996 formed in the throttle yoke 982. The wire hook 1000 may be further provided with a loop 1006 formed in the second distal end 1004. The pair of interface pins 1020, 1022 may be formed of any of a variety of materials such as hardened steel. The first interface pin 1020 may be attached to (e.g. pressed into) the first interface pin hole 990 of the throttle yoke 982. The second interface pin 1022 may be attached to (e.g. pressed into) the second pin interface hole 992 of the throttle yoke 982. The throttle bracket 1030 may be attached to the hub interface 960 in any one of a number of ways. One such attachment method is to attach the throttle bracket 1030 to the hub interface 960 by threaded fasteners as illustrated in FIG. 19. The throttle bracket may have a groove 1032 formed therein for receiving various components of the ignition system.

FIG. 20 shows a perspective view of one exemplary embodiment of a lever arm assembly 1050. With reference to FIG. 20, the lever arm assembly 1050 may be provided with an interface bracket 1060, a spanning bracket 1080, a fork collar 1100 and associated fasteners (e.g. bolts and nuts). The interface bracket 1060 may be provided with a first surface 1062 and an oppositely disposed second surface 1064. The interface bracket 1060 may be further provided with a first distal end 1066 and an oppositely disposed second distal end 1068. The interface bracket 1060 may be further provided with a moment interface 1070 and a pair of threaded holes 1072, 1074. The moment interface 1070 may be any of a variety of forms such as the illustrated square profile. This interface bracket moment interface 1070 is configured to interface with the axle moment interface 214 or 282. The interface bracket 1070 may be made of any of a variety of materials such as, for example, air hardening steel.

With continued reference to FIG. 20, the spanning bracket 1080 may be provided with a first surface 1082 and an oppositely disposed second surface 1084. The spanning bracket 1080 may be further provided with a pair of attachment holes 1086, 1088, a shoulder 1090, and a plurality of collar holes 1092. The attachment holes 1086, 1088 may be formed in the spanning bracket 1080 for allowing attachment to the interface bracket 1070. The shoulder 1090 may be formed on the spanning bracket first surface 1082 and may have the attachment holes 1086, 1088 disposed therein. The plurality of collar holes 1092 may be formed in the spanning bracket 1080 as illustrated and spanning from the first surface 1082 through the second surface 1084.

With continued reference to FIG. 20, the fork collar 1100 may take the form of a clamp capable of wrapping around the individual forks 50, 60 of the pair of forks 18 (FIG. 1). One such configuration of the fork collar 1100 is illustrated in FIG. 20; this configuration may include a cylindrical portion 1102 with a pair of tangs 1104, 1106. The cylindrical portion 1102 and the pair of tangs 1104, 1106 may be one piece of material that is formed into the configuration as shown. The fork collar 110 may be further provided with a pair of holes formed in the tangs 1104, 1106 for receiving fasteners.

FIG. 21 shows a plan view of an as-cast hub 1150 of the hub motor 100. With reference to FIG. 21, the as-cast hub 1150 may be manufactured in a manner that allows it to be substantially symmetrical. This symmetry of the as-cast hub 1150 results in a single casting to be used for either side of the hub motor 100. It should be noted that this configuration may be referred to herein as ‘castingly similar.’ As used herein, the term ‘castingly similar’ is used to describe an article of manufacture that can be used as two components of an assembly (e.g. the left and right sides of the hub motor 100). A castingly similar article of manufacture may be altered in order to make it slightly different in two configurations; an example of this alteration is secondary machining operations to convert the castingly similar as-cast hub 1150 into a right hub 1160 (FIG. 25). Likewise, the as-cast hub 1150 may be altered to convert it into a left hub 1170 (FIG. 25). It is noted that features described with the as-cast hub 1150 may be utilized to describe the right hub 1160 and the left hub 1170.

With continued reference to FIG. 21, the as-cast hub 1150 is, in one exemplary embodiment, made of cast metal (e.g. aluminum). This as-cast hub 1150 is made from a mold that metal is injected into. It can be appreciated by those skilled in the art that this as-cast hub 1150 allows for both the right and left hubs 1160,1170 (FIG. 25) to be made from a single mold. This single mold reduces the cost of manufacturing the hub motor 100 due to the reduction of molds. The as-cast hub 1150 may be provided with a front surface 1180 (FIG. 2) and an oppositely disposed back surface 1182. The as-cast hub 1150 may be provided with a crank bearing mount 1184, an axle bearing mount 1186, a DE bearing mount 1188. As illustrated in FIG. 21, the bearing mounts 1184, 1186, 1188 may be formed on the back surface 1182 of the as-cast hub 1150. The bearing mounts 1184, 1186, 1188 may be configured such that they reside on a common first plane denoted by P1 in FIG. 21.

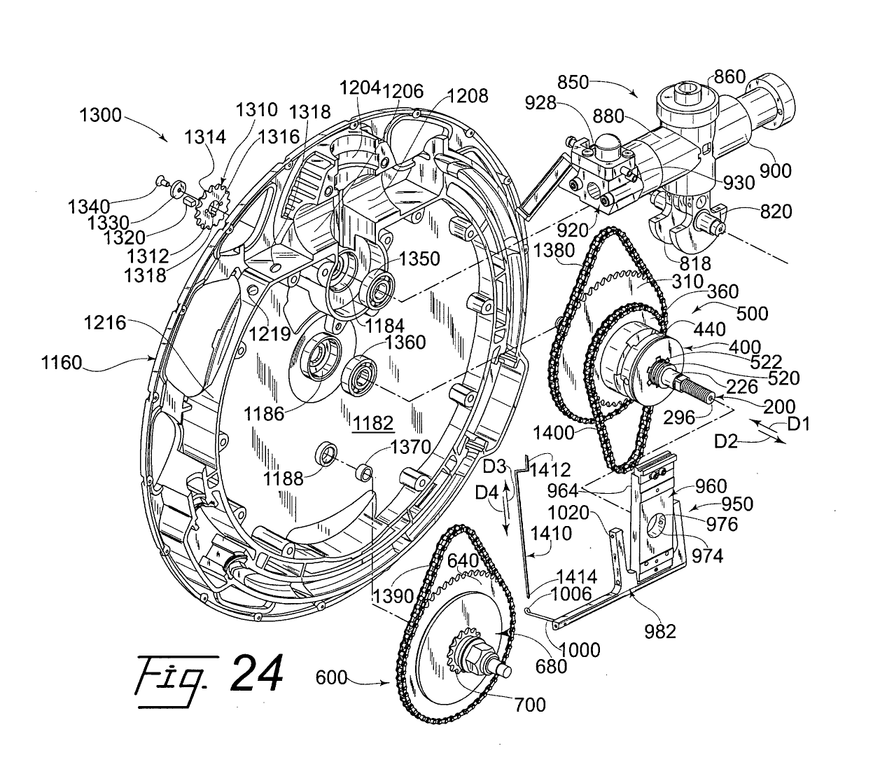

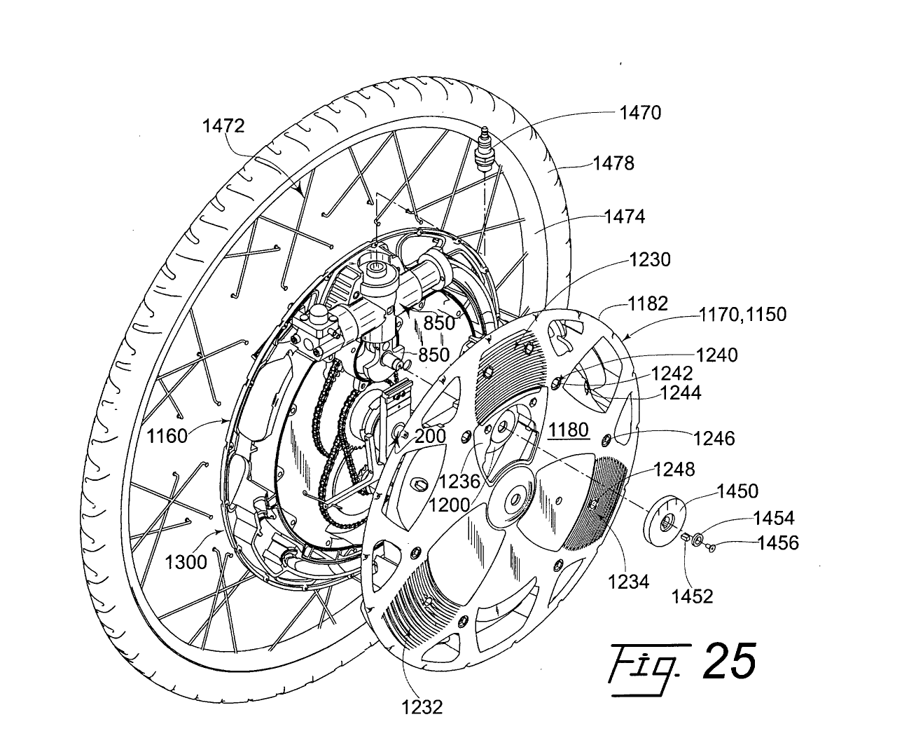

FIG. 22 shows a cross-sectional view of the crank bearing mount 1184 taken across line 22-22 in FIG. 21. With reference to FIG. 22, the crank bearing mount 1184 is configured for receiving a bearing (e.g. crank bearing 1350 illustrated in FIG. 24). FIG. 23 shows a cross-sectional view of the axle bearing mount 1186 taken across line 23-23. With reference to FIG. 23, the axle bearing mount 1186 is configured for receiving a bearing (e.g. axle bearing 1360 illustrated in FIG. 24).

With reference to FIG. 21, the as-cast hub 1150 may be provided with symmetrical features such as a first idler shaft mount 1190 and a second idler shaft mount 1192. The idler shaft mounts 1190, 1192 may be symmetrical to the first plane P1. These symmetrical idler shaft mounts 1190, 1192 are utilized for supporting an idler shaft (if provided) when the as-cast hub 1150 is converted to the right and left hubs 1160, 1170.

With continued reference to FIG. 21, the as-cast hub 1150 may be provided with a crankcase 1200, a transfer port 1202, a sleeve retainer 1204, a pair of manifold retainers 1206, 1208, an exhaust tube 1210, a pair of expansion chambers 1212, 1214, a peripheral wall 1216, a throttle hole 1218 and a fuel line hole 1219. The crankcase 1200 may be formed on the back surface 1182 and be capable of enabling a substantially sealed crankcase to be formed during assembly. The transfer port 1202 may be formed in the back surface 1182 and extend from the crankcase 1200 towards the sleeve retainer 1204. The sleeve retainer 1204 may be formed in the back surface 1182 and may have tapered walls for positioning the sleeve 860. The pair of manifold retainers 1206, 1208 may be formed in the back surface 1182 and be substantially perpendicular to the first plane P1. The exhaust tube 1210 may protrude from the back surface 1182 and be substantially concentric to the center of the as-cast hub 1150. The exhaust tube 1210 may extend from an area substantially near one of the manifold retainers 1206 to the other manifold retainer 1208 as illustrated in FIG. 21. The expansion chambers 1212, 1214 may be formed on the back surface 1182 and be capable of receiving exhaust gasses from the exhaust tube 1210. The peripheral wall 1216 may protrude from the back surface 1192 and be substantially concentric to the center of the as-cast hub 1150. Additionally, the throttle hole 1218 and the fuel line hole 1219 may be formed in the peripheral wall 1216 as part of a process to convert the as-cast hub 1150 into the right hub 1160.

With continued reference to FIG. 21, the as-cast hub 1150 may be provided with a plurality of spoke holes 1220 such as individual spoke holes 1222, 1224, 1226, 1228, 1230. Each of the spoke holes 1220 is separated by and angle of separation N (obtained by dividing the number of spoke holes 1220 by 360 degrees). As illustrated, one exemplary angle of separation N of the spoke holes 1220 is 20 degrees. One of the spoke holes, e.g. spoke hole 1226 is positioned at ¼ N from a first axis located in the first plane P1 (e.g. ¼ of 20 degrees is 5 degrees). This configuration of the spoke holes 1220 allows for the as-cast hub 1150 to be utilized for the right and left hubs 1160, 1170 because the spokes that are fitted into the spoke holes 1220 are evenly spaced and properly support the hub motor 100.

With reference to FIG. 25, although shown in the left hub 1170 configuration of the as-cast hub 1150, the as-cast hub 1150 may be provided with a plurality of cooling fins 1230, a first set of counterbalance fins 1232, a second set of counterbalance fins 1234 and a core through opening 1236. The cooling fins 1230 are formed in the front surface 1180 of the as-cast hub 1150 at a location near the transfer port 1202, sleeve retainer 1204 and pair of manifold retainers 1206, 1208. These cooling fins 1230 serve to increase heat dissipation from the wheel motor 100 to the surrounding environment. The first and second sets of counterbalance fins 1232, 1234 may be located at a predetermined location on the front surface 1180. One such predetermined location of the counterbalance fins 1232, 1234 may be equally spaced at 120-degree increments as illustrated in the figures. This positioning of the counterbalance fins 1232, 1234 assists with obtaining an equal distribution of the rotating mass of the hub motor 100 and also aesthetically balances the overall design. The core through opening 1236 may be formed in the front surface 1180 at the crankcase 1200. The core through opening 1236 allows for a simple two-piece mold to be utilized during the casting process, thereby eliminating an expensive collapsible-core in the mold.

With continued reference to FIG. 25, the as-cast hub 1160 may be provided with a plurality of mounting holes 1240 such as individual mounting holes 1242, 1244, 1246, 1248. The mounting holes 1240 extend from the front surface 1180 to the back surface 1182 and be of a large enough diameter to accommodate fasteners. Furthermore, the mounting holes 1240 may be formed with a hexagonal portion at the front surface 1180. This hexagonal portion receives a nut and restricts rotation of the nut during installation.

Having provided detailed descriptions of exemplary components of the present hub motor 100, an exemplary assemblage of these components will now be provided. It is to be understood that this exemplary assembly may be configured in any of a number of manners, and this is only one exemplary process of assembling the components.

FIG. 24 shows a perspective view of a right hub assembly 1300 in an exploded condition. The right hub assembly 1300 may be provided with the right hub 1160, the engine assembly 850, the axle assembly 500 and the shaft DE assembly 600. Additional components not yet described may also be provided with the right hub assembly 1300. Additional components may include a sprocket A 1310, a sprocket key 1320, a sprocket cap 1330, a sprocket bolt 1340, a first crank bearing 1350, a first axle bearing 1360, a first shaft DE bushing 1370, a first chain 1380, a second chain 1390, a third chain 1400 and a throttle wire 1410. With continued reference to FIG. 24, the sprocket A 1310 may be provided with a first surface 1312 and an oppositely disposed second surface 1314. The sprocket A 1310 may be further provided with a hole 1316 formed between the first and second surfaces 1312, 1314. The sprocket A 1310 may be further provided with a keyway 1318 formed in the hole 1316. The chains 1380, 1390, 1400 may be any of a variety of power transmission devices such as, but not limited to, belts, roller chains, cables, etc. In one exemplary embodiment, the chains 1380, 1390, 1400 are ANSI number 25 roller chains. The throttle wire 1410 may be provided with a z-bend 1412 formed in one distal end and a pivot attachment 1414 formed in the opposite distal end.

With continued reference to FIG. 24, the process of assembling the right hub assembly 1300 may begin by pressing the crank bearing 1350 into the first crank bearing mount 1184, pressing the first axle bearing 1360 into the axle bearing mount 1186 and the first shaft DE bushing 1370 into the DE bearing mount 1188. The engine assembly 850 may now be assembled with the right hub 1160 such that the sleeve 860 is registered to the right hub 1160 via the sleeve retainer 1204. When assembling the engine assembly 850 with the right hub 1160, the exhaust manifold 900 may contact the manifold retainer 1208. The contact areas of the engine assembly 850 and the right hub 1160 may be sealed by using an anaerobic sealing compound. This assembling also results in the first cheek plate 818 contacting the first crank bearing 1350. After installing the engine assembly 850 to the right hub 1160, the sprocket A 1310 may be attached to the first cheek plate 818 via the sprocket key 1320 interacting with the keyway 1318 formed in the sprocket A 1310. The sprocket key 1320 and sprocket A 1310 are held in position with the sprocket cap 1330 and the sprocket bolt 1340.

After installing the engine assembly 850 into the right hub 1160, the axle assembly 500 may be installed into the right hub 1160. When installing the axle assembly 500, the fourth bearing surface 278 (FIG. 14) of the axle 200 contacts the first axle bearing 1360. This installation of the axle assembly 500 results in the spacer 334 (FIG. 7) of the BC sprocket assembly 300 contacting the first axle bearing 1360. When the axle assembly 500 is installed into the right hub assembly 1300, the first chain 1390 is positioned such that it contacts sprocket A 1310 and sprocket B 310. Next, the shaft DE assembly 600 can be installed into the right hub assembly 1300. When installing the shaft DE assembly 600, the shaft DE second bearing surface 624 (FIG. 15) contacts the first shaft DE bushing 1370 and the shaft DE second distal end 614 contacts the back surface 1182 of the right hub 1160. When the shaft DE assembly 600 is installed into the right hub assembly 1300, the second chain 1390 is positioned such that it contacts the sprocket D 640 and sprocket C 320 (FIG. 14). Additionally, the third chain 1400 is positioned such that it contacts sprocket E 700 and sprocket F 360.

After installing the components of the hub motor 100 associated with the transmission of power, the hub interface assembly 950 may be installed into the right hub assembly 1300. The hub interface assembly 950 is assembled with the throttle wire 1410 via the wire hook loop 1006. After attaching the throttle wire 1410 to the loop 1006 of the wire hook 1000, the z-bend 1412 of the throttle wire 1410 is fed through the throttle hole 1218. The throttle wire z-bend 1412 is attached to the throttle plate 928 of the carburetor 920. After attaching the throttle wire 1410 to the carburetor 920, the hub interface assembly 950 may be interfaced with the axle 200. When interfacing the hub interface assembly 950 with the axle 200, the axle hole 974 formed in the hub interface 960 is positioned concentric to and in contact with the pair of o-rings 520, 522. This interfacing also places the second surface 964 of the hub interface 960 adjacent to the fourth shoulder 232 (FIG. 4) of the axle 200. When interfacing the hub interface assembly 950 with the axle 200, the pair of interface pins 1020, 1022 are positioned in the circumferential groove 440 formed in the outer cylindrical surface 408 (FIG. 11) of the starter plate 400. After the hub interface assembly 950 is properly installed on the axle 200, a fuel line (not shown) is routed through the inside of the right hub assembly 1300, through the fuel line hole 1219 and attached to the hub interface fuel delivery hole 976 and the carburetor fuel inlet 930. This connection between the hub interface fuel delivery hole 976 and the carburetor fuel inlet 930 places the hub interface fuel delivery hole 976 in fluid communication with the carburetor fuel inlet 930. It should be appreciated to those skilled in the art that this attachment of the fuel line, carburetor 920, hub interface 960 and the axle 200 allow fuel to be transferred from the cavity 296 to the carburetor 920 as the hub motor 100 rotates.

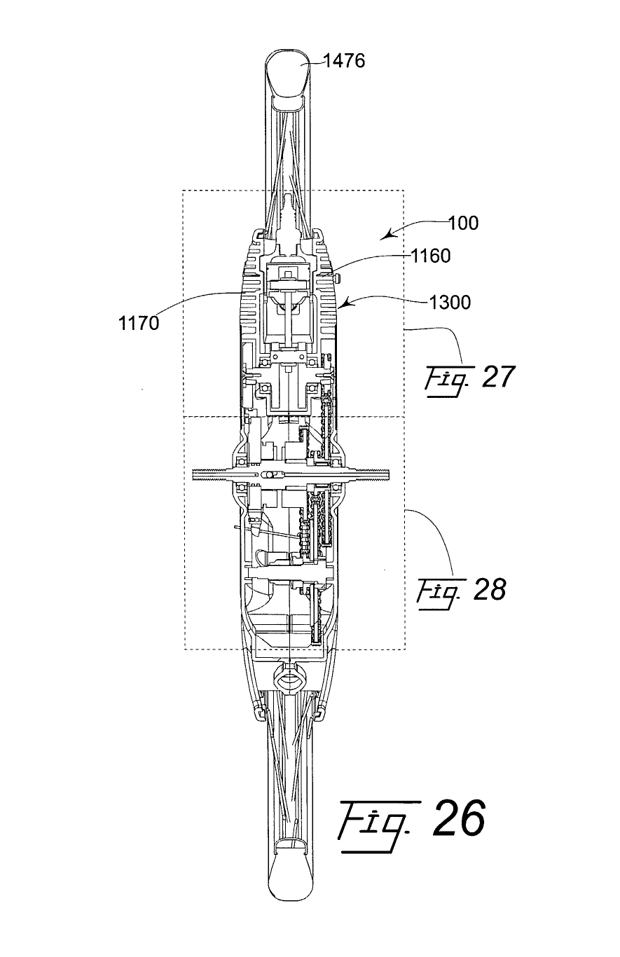

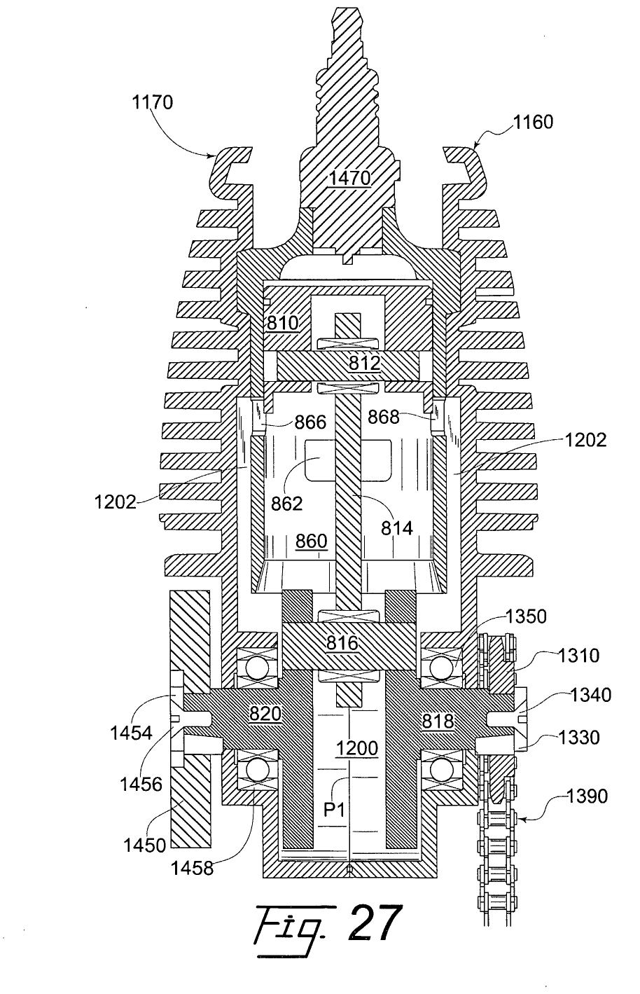

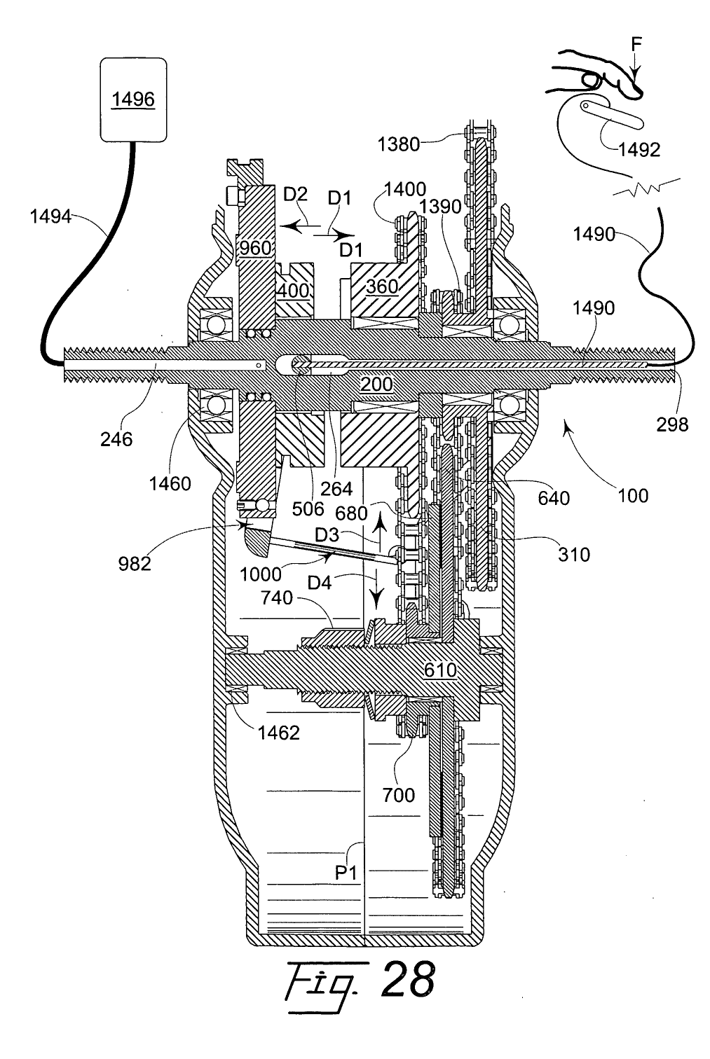

After assembling the right hub assembly 1300, the entire hub motor 100 may be assembled. FIG. 25 shows a perspective view of the hub motor 100 in an exploded condition. With reference to FIG. 25, the hub motor 100 may be provided with the right hub assembly 1300, the left hub 1700, a flywheel 1450, a flywheel key 1452, a flywheel cap 1454, a flywheel bolt 1456, a second crank bearing 1458 (FIG. 27), a second axle bearing 1460 (FIG. 28), a second shaft DE bushing 1462 (FIG. 28), a spark plug 1470, a plurality of spokes 1472, a rim 1474, a tube 1476 (FIG. 26) and a tire 1478. The process of assembling the entire hub motor 100 may, for example, begin by attaching the left hub 1700 to the right hub assembly 1300. When attaching the left hub 1700 to the right hub assembly 1300, the sleeve 860 is registered to the left hub 1170 via the sleeve retainer 1204 (FIG. 24). When assembling the engine assembly 850 with the left hub 1170, the exhaust manifold 900 may contact the manifold retainer 1208 (FIG. 24). The contact areas of the engine assembly 850 and the left hub 1170 may be sealed by using an anaerobic sealing compound. This assembling also results in the second cheek plate 820 contacting the second crank bearing 1458 (FIG. 27). After attaching the left hub 1700 to the right hub assembly 1300, the flywheel 1450 may be attached to the second cheek plate 820 via the flywheel key 1452 interacting with the keyway formed in the flywheel 1452. The flywheel key 1452 and the flywheel 1450 are held in position with the flywheel cap 1454 and the flywheel bolt 1456. When installing the left hub 1170 the first bearing surface 226 (FIG. 4) of the axle 200 contacts the second axle bearing 1460 (FIG. 28). This installation also results in the third shoulder 228 (FIG. 4) of axle 200 contacting the second axle bearing 1460 (FIG. 28).

With continued reference to FIG. 25, the right hub assembly 1300 and the left hub 1170 are attached to each other by installing bolts and nuts into the plurality of mounting holes 1240. It should be apparent to those skilled in the art that when the hubs 1160, 1170 are attached to each other, either the right or left hub 1160, 1170 receives the bolts and the other hub receives the nuts. The hexagonal portion of the mounting holes 1240 are large enough to receive the nuts and restrict their rotation (which assists with the assembly of the hub motor 100. After securing the bolts and nuts, additional components may be secured to the hub motor 100 such as, for example, the spark plug 1470, cover plates (e.g. a left cover plate 1480, FIG. 2), the spokes 1472, the rim 1474, the tube 1476 (FIG. 26) and the tire 1478.

FIG. 26 illustrates a cross-sectional view taken across line 26-26 if FIG. 2 of the exemplary configuration of the previously described embodiment. With reference to FIG. 26, in order to clearly represent the exemplary configuration, enlarged portions of FIG. 26 are shown in FIGS. 27 and 28. FIG. 27 shows the top-half of the hub motor 100 and FIG. 28 shows the bottom-half of the hub motor 100.

With reference to FIG. 28, the hub motor 100 may be further provided with a throttle cable 1490, a throttle lever 1492, a fuel line 1494, and a fuel tank 1496. One end of the throttle cable 1490 is inserted; into the cavity 298 of the axle 200 and attached to the throttle pin 506 (e.g. via the hole 510, FIG. 14) while the other end of the throttle cable 1490 is attached to the throttle lever 1492. The throttle lever 1492 may be attached to any location on the exemplary vehicle (e.g. bicycle 10), such as, for example, on the handlebars 20 (FIG. 1). This attachment of the throttle lever 1492 to the starter plate 400 via the throttle cable 1490 and the throttle pin 506 places the throttle plate 928 of the carburetor 920 in mechanical communication with the user of the bicycle 10.

With continued reference to FIG. 28, one end of the fuel line 1494 is attached to the fuel passage 246 formed in the axle 200. The other end of the fuel line 1494 is attached to the fuel tank 1496. The fuel tank 1496 may be attached at any location to the exemplary vehicle (e.g. bicycle 10), such as, for example to a bottle cage attached to the frame of the bicycle 10. This attachment of the fuel tank 1496 to the fuel passage 246 places the carburetor 920 in fluid communication with the fuel tank 1496.

FIG. 29 shows a perspective view of the hub motor 100 attached to an exemplary pair of forks 18. With reference to FIG. 19, the hub motor 100 may be attached to the forks 18 via the axle 200. When attaching the hub motor 100 to the forks 18, two lever arm assemblies 1050 may be utilized. As illustrated in FIG. 29, one of the lever arm assemblies 1050 is installed onto the axle 200 such that the interface bracket moment interface 1070 (FIG. 20) engages the axle moment interface 214 (FIG. 3). The fork collar 1100 is attached to the first fork 50 and a fastener (not shown) is utilized to engage the spanning bracket 1080 of the lever arm assembly 1050 to the first fork 50 via the fork collar 1100. It should be apparent from FIG. 29 that a second lever arm assembly 1050 is attached to the other side of the axle 200 and interfaced with the second fork 60 in a similar manner as previously described.

One sub-system of the hub motor 100 is an ignition system (not shown). One exemplary type of ignition system may include a circuit box, a sparkplug wire, a sensor, a magnet, a battery and a switch. Although any of a number of ignition systems may be utilized, the Model 26 ignition system manufactured and sold by C.H. Ignitions, Inc. of Riverton, Wyo., USA has proven to be effective. Although ignition systems are well-known to those skilled in the art, a brief description will be provided. Energy is stored in the battery and transferred to a sparkplug via the circuit box and the sparkplug wire. This energy is transferred to the sparkplug at an exact point in time when the piston is at a specific location in the sleeve. When the piston is at this specific location in the sleeve, a magnet (mounted on the flywheel) passes the sensor and thereby indicates to the circuit box to send the energy to the sparkplug. Another type of ignition systems is a magneto. The magneto generates alternating-current as permanent magnets pass the magneto (or ferrous components contained therein). This alternating-current may be conditioned (usually increased in voltage) to cause the sparkplug to spark when the current is applied thereto.

Having described exemplary components of one configuration of the hub motor 100 and the exemplary assembly of these components, various interactions between the components will now be described. These various interactions include: an off condition wherein the hub motor 100 is not producing power; combustion of the fuel in the engine assembly 850; movement of the throttle plate 928 of the carburetor 920; delivery of fuel to the fuel inlet 930 of the carburetor 920; transmission of power from the engine assembly 850 to the vehicle; movement of the starter plate 400 to cause starting; and operation of the torque fuse 680.

When the vehicle (e.g. bicycle 10) is being used without power-assistance, the hub motor 100 simply overruns the axle 200; this condition may be referred to herein as the ‘off condition’. The off condition of the hub motor 100 will now be described. During the off condition, the hub motor 100 doe not consume any fuel. In this condition, the overrunning clutch 380 of the sprocket F assembly 350 may allow for the hub motor 100 to ‘overrun’ the axle 200. As used herein the term ‘overrun’ may be defined as a condition wherein a first element is allowed to rotate freely around a second element. In the case of the sprocket F assembly overrunning clutch 380, the sprocket F 360 may rotate freely about the axle 200. In this off condition, the bicycle 10 may be used as a conventional transportation device by pedaling the cranks 40 and the hub motor 100 does not impart any forces on the forward movement.

With reference to FIG. 18, combustion of the fuel in the engine assembly 850 will be described. During the operating condition, the engine assembly 850 accelerates the bicycle 10 by taking in clean combustible mixture, compressing the combustible mixture, igniting the combustible mixture (thereby creating a spent mixture) and exhausting the spent mixture. The process of igniting combustible mixtures is well known in the art of internal combustion engines, however a brief description will now be provided. At the outset, the fuel obtained from the carburetor fuel inlet 930 is mixed with air to create a mixture that is then drawn into the crankcase 1200 (FIG. 27) through the intake port 862. This mixture located in the crankcase 1200 is urged into the sleeve 860 through the transfer ports 866, 868. The piston 810 moves thereby compressing the combustible mixture in the sleeve 860. At the top of the stroke of the piston 810, the ignition system sends current to the sparkplug 1470 (FIG. 25). The sparkplug 1470 ignites the compressed combustible mixture thereby moving the piston 810. This piston movement in then imparts a force on the sprocket A 1310 via the connecting rod 814 and the cheek plate 818. Once the piston 810 passes the exhaust port 864, the spent gas may be expelled from the sleeve 860. As the spent gas is expelled, the combustible mixture is drawn into the sleeve 860 through the transfer ports 866, 868. The process continues as required, thereby providing rotation of the sprocket A 1310. This rotation of the sprocket A 1310 may be transmitted through the hub motor 100 to cause rotation of the hub motor 100. Rotation of the hub motor 100 is mirrored by the rim 130 and tire 132. Rotation of the tire 132 urges the bicycle 10 forward.

With reference to FIG. 24, movement of the carburetor throttle plate 928 occurs via the interaction of the pair of interface pins 1020, 1022 positioned in the starter plate circumferential groove 440. This interaction results in the carburetor 920 being controlled by the position of the starter plate 400. As the starter plate 400 moves in a first direction D1 and a second direction D2, the wire hook 1000 moves via the throttle yoke 982. This movement of the wire hook 1000 causes the throttle wire 1410 to move in a third direction D3 and a fourth direction D4. In other words, as the starter plate 400 moves in the first direction D1, the throttle wire 1410 moves in the fourth direction D4, which causes the carburetor 920 to open via movement of the throttle plate 928. As described later herein, opening of the throttle plate 928 causes the hub motor 100 to speed up.

With reference to FIG. 24, movement of the starter plate 400 may also cause starting of the engine. When the starter plate 400 is moved along the first direction D1, the throttle plate 928 of the carburetor opens to a wide-open position. This ‘wide-open position’ is described herein as the furthest extent that the throttle plate 928 can move, therefore, the throttle wire 1410 can not move any further in the fourth direction D4. When the hub motor 100 is started the starter plate 400 is moved in the first direction D1 until the starter plate dogs 420 engage the sprocket F dogs 370, 372, 374. When the dogs are engaged, sprocket F 360 is not able to rotate with respect to the axle 200. When sprocket F 360 is engaged while the hub motor 100 is rotating in the counter clockwise direction CCW, the piston 810 is urged to move inside the sleeve 860. This movement is harnessed to start the engine.

When starting the engine, the instantaneous transmission of power to the engine may ‘shock’ the system. Therefore, the torque fuse 680 may be employed to protect components of the hub motor 100. For example, the torque fuse 680 may be employed when a user of the bicycle 10 desires to start the hub motor 100 while traveling at a moderate to fast sped (e.g. 7-20 miles per hour). The user activates the throttle lever 1492 to, in turn, cause the starter plate 400 to move in the first direction D1. The starter plate 400 locks the sprocket F 360 to the axle 200 thereby causes rotation of sprocket E 700 via the third chain 1400. When this instantaneous rotation of sprocket E 400 causes the torque applied to the torque fuse 680 to exceed the predetermined torque, the friction material 686 slips against the first surface 642 of the sprocket D 640. As the torque fuse 680 slips, it does apply a load onto the second chain 1390. The second chain 1390 applies energy to the sprocket BC assembly 300, which, in turn, causes rotation of the sprocket A 1310 via the first chain 1380. Rotation of sprocket A 1310 causes movement of the piston 810 which eventually causes the engine to start. Once the engine is running, it applies power to the sprocket A 1310. The sprocket A 1310 transmits the power to the axle 200 via the chains 1380, 1390, 1400 and associated sprockets. This power applied to the axle 300 is transmitted to the forks via the lever arms 1050. Since the axle 200 can not spin with respect to the forks 18, the hub motor 100 speeds up in the counter clockwise direction CCW to speed the bicycle 10 in the forward direction.

The previously-described driven condition continues until the user desires to slow down. In order to slow down, the user releases the throttle lever 1492 and the starter plate 400 moves in the second direction D2. The throttle plate 928 of the carburetor 920 is attached to the starter plate 400 via the throttle yoke 982 and throttle wire 1410, therefore releasing the throttle lever 1492 closes the throttle plate 928. As well known in the art, closing of a throttle plate (e.g. throttle plate 928) on a carburetor (e.g. carburetor 920) causes the engine to slow down as delivery of air and fuel are restricted. This slowing down causes the overrunning clutch 380 of the sprocket F assembly 350 to allow sprocket F 360 to overrun the axle 200. The user comes to a stop and the engine dies due to the lack of power because the throttle plate 928 of the carburetor 920 is closed.

With reference to FIG. 28, fuel is delivered to the carburetor fuel inlet 930 via the fuel tank 1496, the fuel line 1494, the axle fuel passage 246, the hub interface the fuel line (not shown) routed through the fuel line hole 1219. As the wheel 14 is rotating, the fuel is pumped from the fuel tank 1496 into the fuel line 1494. This fuel continues towards the carburetor 920 by entering into the fuel passage 246 of the axle 200. Once the fuel is inside the fuel passage 246, it enters into the void located between the axle fuel interface 230 (FIG. 4) and the axle hole 974 formed in the hub interface 960. It should be noted that the pair of o-rings 520, 522 retain the fuel in the void located between the axle fuel interface 230 and the hub interface axle hole 974. The fuel continues from the void into the fuel delivery hole 976 and therefore into the fuel line (not shown) that is attached to the carburetor fuel inlet 930. The process of pumping the fuel from with the diaphragm pump includes transferring the crankcase pressure to the carburetor. The crankcase pressure is directed to the carburetor 920 via the bypass passages 888,890, the intake manifold diaphragm passage 886 and the carburetor insulator diaphragm passage 916. The pressure of the crankcase alternates and drives a plastic diaphragm back and forth as a series of check valves control the flow of fuel within the carburetor 920.

Ignoring all of the inner-workings of the hub motor 100, a user's experience of using the hub motor 100 will be described. The user gets on the bicycle 10, pedals the bicycle, pushes on the throttle lever 1492 and the engine starts. The hub motor 100 powers the bicycle 10 along until the user desires to slowdown or stop. When the user desires to reduce speed, the throttle lever 1492 is released and the engine starts to die. Brakes provided with the bicycle 10 are activated and the user slows down or comes to a stop. At the present time and as configured, the hub motor 100 does not idle at stop, it simply shuts off. When the user desires to continue, the above process repeats.

In one exemplary embodiment, the sprockets and chains may be substituted with any one (or a combination) of a variety of power transmission devices such as, but not limited to, gears, belts, timing chains or other devices for transferring power.

In another exemplary embodiment, the exhaust tube 1210 and pair of expansion chambers 1212, 1214 may be removed and an external muffler and/or intake may be provided adjacent to the peripheral wall 1216.

As can be appreciated by anyone with transportation needs, the present device and methods can provide simple, inexpensive and reliable transportation. The device consumes minimal amounts of fuel, yet provides ample power for moving people and/or objects.

While illustrative embodiments have been described in detail herein, it is to be understood that the inventive concepts may be otherwise variously embodied and employed and that the appended claims are intended to be construed to include such variations except insofar as limited by the prior art.

What is claimed is:

1. A wheel for a transportation device comprising:
an engine defining a piston axis;
a first hub-half defining a first plane;
a second hub-half defining a second plane;
wherein said first hub-half is attached to said second hub-half; and
wherein said first plane and said second plane are coplanar.

2. The wheel of claim 1 wherein said piston axis resides in said first plane and said second plane.

3. The wheel of claim 1 wherein said engine is captured by said first and said second hub-halves.

4. The wheel of claim 1 wherein said second hub-half is castingly similar to said first hub-half.

5. The wheel of claim 1 and further comprising:
a plurality of fins formed in said hub-halves.

6. The wheel of claim 1 and further comprising:
a first crankcase-half formed in said first hub-half; and
a second crankcase-half formed in said second hub-half.

7. The wheel of claim 1 and further comprising:
a plurality of spoke holes formed in said first hub-half, said plurality of spoke holes equally spaced by a number of degrees;
a vertical axis defined by said first hub-half; and
wherein one of said plurality of spoke holes is formed at a location of one-quarter of said number of degrees from said vertical axis.

8. The wheel of claim 1 and further comprising:
a bearing support formed in said first hub-half.

9. A wheel for a transportation device comprising:
an engine formed in said wheel;
an axle about which said wheel rotates;
a starter non-rotatably engaged with said axle; and
wherein said starter is translatingly engaged with said axle.

10. The wheel of claim 9 and further comprising:
a keyed interface formed in said axle and said starter.

11. The wheel of claim 10 and further comprising:
a plurality of keys formed in said axle; and
a plurality of keyways formed in said starter.

12. The wheel of claim 11 and further comprising:
at least one slot formed in said axle;
wherein said axle defines a central axis; and
wherein said slot is parallel to said central axis.

13. The wheel of claim 12 and further comprising:
a hole formed in said axle and co-radial to said central axis;
wherein said axle defines a first distal end; and
wherein said hole is formed into and between said first distal end and said slot.

14. The wheel of claim 9 and further comprising:
at least one dog formed in said starter.

15. The wheel of claim 14 wherein said dog is formed with a tapered face.

16. The wheel of claim 15 wherein said dog is formed with a tapered face with an angle of at least 1 degree.

17. The wheel of claim 15 wherein said dog is formed with a tapered face with an angle less than 10 degrees.

18. The wheel of claim 9 and further comprising a starter pin engaging said starter to said axle.

19. The wheel of claim 9 and further comprising:
a circumferential groove formed in said starter.

20. A wheel for a transportation device comprising:
an axle about which said wheel rotates;
a hub assembly rotationally supported by said axle;
a carburetor attached to said hub assembly;
a starter plate translatingly interfaced with said axle; and
a yoke pivotally attached to said hub assembly wherein said yoke is rotationally interfaced with said starter plate and controllingly interfaced with said carburetor.

21. The wheel of claim 20 and further comprising:
a wide open condition of said carburetor;
a throttled condition of said carburetor;
wherein, in said wide open condition, said starter plate is at a first position on said axle; and
wherein, in said throttled condition, said starter plate is at a second position on said axle that is different than said first position.

22. The wheel of claim 20 and further comprising:
a circumferential groove formed in said starter plate;
at least one pin formed on said yoke; and
wherein said pin is engaged with said circumferential groove.

23. A wheel for a transportation device comprising:
an engine formed in said wheel, said engine creating torque;
an axle about which said wheel and said engine rotates;
a lever arm non-rotationally interfaced with said axle and fixedly attached to said transportation device; and
wherein said torque is transferred from said engine to said transportation device via said lever arm.

24. The wheel of claim 23 and further comprising:
a male-keyed portion formed in said axle;
a female-keyed portion formed in said lever arm; and
wherein said female keyed portion is adjoining said male-keyed portion.

25. The wheel of claim 24 wherein said keyed portions are formed with a draft angle.

26. The wheel of claim 23 and further comprising:
a circumferential clamp adjoining said transportation device; and
wherein said lever arm is fixedly attached to said transportation device via said circumferential clamp.

27. The wheel of claim 23 wherein said lever arm comprises:
a first leg; and
a second leg transverse to said first leg.

28. The wheel of claim 24 wherein said male-keyed portion comprises a first surface and an oppositely disposed second surface.

29. The wheel of claim 28 and further comprising:
a central axis defined by said axle;
a draft angle of said first and said second surfaces, said draft angle defined by the angle of intersection of said first and said second surfaces to said central axis; and
wherein said draft angle is at least ½ degree.

30. The wheel of claim 27 wherein said first leg is offset at least 0.25 inches from said second leg.

31. A wheel for a transportation device comprising:
an engine formed in said wheel;
an axle about which said wheel rotates; and
a torque fuse formed between said engine and said axle.

32. The wheel of claim 31 and further comprising:
a first gear rotationally coupled to said engine;
a second gear readily coupled to said axle; and
wherein said torque fuse is formed between said first and said second gears.

33. The wheel of claim 32 and further comprising:
a slip condition and a drive condition of said torque fuse;
wherein, in said slip condition, said first gear rotates with respect to said second gear; and
wherein, in said drive condition, said first gear is stationary with respect to said second gear.

34. The wheel of claim 32 and further comprising a friction plane formed between said first and said second gears.

35. The wheel of claim 34 and further comprising
a friction material formed on said second gear; and
a wear surface formed on said first gear.

36. The wheel of claim 35 and further comprising:
a spring urging said friction material against said wear surface.

37. A wheel for a transportation device comprising:
an engine formed in said wheel;
a carburetor in fluid communication with said engine;
a crankcase formed in said hub; and
a diaphragm pump in pneumatic communication with said crankcase and in fluid communication with said carburetor.

38. The wheel of claim 37 and further comprising:
a hub assembly formed around said engine;
a transfer passage formed in said hub assembly;
wherein said transfer passage places said crankcase in fluid communication with said engine; and
wherein said diaphragm pump is in pneumatic communication with said crankcase via said transfer passage.

39. A wheel for a transportation device comprising:
an axle about which said wheel rotates, said axle defining a first distal end;
a fuel supply attached to said transportation device;
an engine formed in said wheel;
a fuel interface stationarily attached to said wheel; and
a fuel passage formed in said axle, said fuel passage providing fluid communication between said first distal end and said carburetor via said fuel interface.

40. The wheel of claim 39 and further comprising:
a first sealing surface formed on said axle; and
wherein said first sealing surface is sealingly engaged with said fuel interface.

41. The wheel of claim 40 and further comprising:
a sealing surface formed on said axle and offset from said first sealing surface; and
wherein a portion of said fuel passage is formed between said first and said sealing surfaces.

42. Method of starting a motorized wheel comprising:
providing an engine formed in said motorized wheel;
providing an axle about which said motorized wheel rotates;
providing a torque fuse drivingly engaged with said axle and said engine;
starting said engine; and
while starting said engine, causing activation of said torque fuse.

43. A wheel for a transportation device comprising:
an engine formed in said wheel;
a starter drivingly engaged to said engine;
a carburetor in fluid communication with said engine;
a starter/throttle mechanism in mechanical communication with said starter; and
wherein said starter/throttle mechanism is in mechanical communication with said carburetor.

44. A method for starting a motorized wheel for a transportation device, said method comprising:
providing an engine formed in said wheel;
providing a starter drivingly engaged to said engine;
providing a carburetor in fluid communication with said engine;
providing a starter/throttle mechanism in mechanical communication with said starter;
wherein said starter/throttle mechanism is in mechanical communication with said carburetor;
starting said engine by activating said starter/throttle mechanism; and
after said starting said engine, controlling said engine with said starter/throttle mechanism.
